(19) United States
(12) Patent Application Publication
(10) Pub. No.: US 2020/0150857 A1
(43) Pub. Date: May 14, 2020

(54) HAPTIC-ENABLED DISPENSER FOR DISPENSING CONSUMABLE SUBSTANCE

(71) Applicant: IMMERSION CORPORATION, San Jose, CA (US)

(72) Inventors: David M. BIRNBAUM, Oakland, CA (US); Danny A. GRANT, Laval (CA)

(21) Appl. No.: 16/186,377

(22) Filed: Nov. 9, 2018

(51) Int. Cl. G06F 3/0484; G06F 3/01; G06F 3/0488

(52) U.S. Cl. CPC G06F 3/04847; G06F 3/04883; G06F 3/016

(57) ABSTRACT

A haptic-enabled dispenser for dispensing a consumable substance is provided. The haptic-enabled dispenser comprises a housing having a passage and a haptic portion, the housing configured to dispense the consumable substance via the passage to an outlet of the housing. The haptic-enabled dispenser further comprises a haptic output device disposed at the haptic portion of the housing. The haptic-enabled dispenser further comprises a control circuit configured to control the haptic output device to generate a haptic effect at the haptic portion of the housing of the haptic-enabled dispenser.

### FIELD OF THE INVENTION

The present invention is directed to a haptic-enabled device for dispensing a consumable substance that can be ingested or inhaled by a user, such as vapor, aerosol, a liquid, or a solid.

### BACKGROUND

Consumable substances that can be ingested and/or inhaled may be made available for user consumption via a haptic-enabled dispenser for dispensing such consumable substances. Examples of a haptic-enabled dispenser for dispensing consumable substances may include an electronic vaporizing device, e-cigarettes, an aerosol haptic-enabled dispenser, etc. With advancement of technologies, components providing various effects have become available for implementation in the haptic-enabled dispensers. Such effects may be based on various factors associated with the haptic-enabled dispensers and may provide rich user experience as users utilize the haptic-enabled dispensers to ingest or inhale the consumable substances. As such, the haptic-enabled dispensers for dispensing consumable substances may be improved to enhance user experience by implementing various effects such as haptic effects.

### SUMMARY

One aspect of the embodiments herein relates to a haptic-enabled dispenser for dispensing a consumable substance, the haptic-enabled dispenser comprising: a housing having a passage and a haptic portion, the housing configured to dispense the consumable substance via the passage to an outlet of the housing. The haptic-enabled dispenser further comprises a haptic output device disposed at the haptic portion of the housing. The haptic-enabled dispenser further comprises a control circuit configured to control the haptic output device to generate a haptic effect at the haptic portion of the housing of the haptic-enabled dispenser.

In an embodiment, the haptic-enabled dispenser further comprises a conversion component configured to convert a pre-consumable substance to the consumable substance.

In an embodiment, the consumable substance includes at least one of an inhalable vapor, an inhalable aerosol, an ingestible liquid, or an ingestible solid.

In an embodiment, the haptic-enabled dispenser further comprises a user interaction component configured to collect user interaction data including information on user interaction with the haptic-enabled dispenser, wherein the control circuit is configured to control the haptic output device to generate the haptic effect based on the user interaction data. In such an embodiment, the interaction data includes at least one of a dispensed amount of the consumable substance, user touch data, or a position data with respect to a user position and a position of the haptic-enabled dispenser.

In an embodiment, the haptic-enabled dispenser further comprises a memory device configured to store data and a communication interface configured to perform data communication, wherein the control circuit is configured to receive a haptic track via the communication interface, and to store the haptic track on the memory, wherein the haptic effect is generated based on the haptic track.

In an embodiment, the haptic output device comprises an actuator configured to vibrate to provide the haptic effect, at least one electrode disposed on a surface of the housing to provide the haptic effect, a temperature regulator configured to change a temperature within the housing to generate the haptic effect, a flow regulator configured to regulate a flow of the substance through the passage to generate the haptic effect, or a combination thereof.

In an embodiment, the haptic output device is configured to generate at least one of a vibrotactile effect, electrical stimulus effect, a thermal effect, a friction effect, a force effect, or an ultrasonic effect.

In an embodiment, the housing has an interior wall that forms the passage, wherein the haptic output device comprises at least one of an interior layer of an interior haptic output component directly disposed on the interior wall at the mouthpiece portion or body portion, or an exterior layer of an exterior haptic output component disposed on an exterior of the mouthpiece or exterior of the body. In an embodiment, the interior haptic output component comprises a plurality of interior haptic output components spaced apart from one another, and the exterior haptic output component comprises a plurality of exterior haptic output components spaced apart from one another. In an embodiment, the interior haptic output component is configured to generate a first haptic effect and the exterior haptic output component is configured to generate a second haptic effect different from the first haptic effect.

In an embodiment, the haptic-enabled dispenser further comprises a flow sensor to sense a flow rate of the consumable substance through the passage, wherein the control circuit is further configured to control the haptic output device to adjust an intensity of the haptic effect based on the flow rate of the consumable substance.

In an embodiment, the housing further comprises at least one of a mouthpiece portion or a handle portion, the at least one of the mouthpiece portion or the handle portion having the haptic portion.

One aspect of the embodiments herein relates to a haptic-enabled dispenser for dispensing a consumable substance. The haptic-enabled dispenser comprises a housing having a passage and configured to dispense the consumable substance via the passage to an outlet in at least one portion of the passage. The haptic-enabled dispenser further comprises a temperature sensor configured to sense an interior temperature of the haptic-enabled dispenser. The haptic-enabled dispenser further comprises a control circuit configured to generate a temperature control signal based on the interior temperature sensed and a target temperature. The haptic-enabled dispenser further comprises a temperature regulator configured to receive the temperature control signal and to change the interior temperature of the haptic-enabled dispenser to provide a haptic-effect based on the temperature control signal.

In an embodiment, the haptic-enabled dispenser further comprises a conversion component configured to convert a pre-consumable substance to the consumable substance.

In an embodiment, the temperature regulator comprises a thermoelectric device to heat or cool an interior of the haptic-enabled dispenser to provide the haptic effect based on the temperature control signal.

In an embodiment, the temperature regulator includes at least one of a heater included in the conversion component and configured to change heat intensity based on the temperature control signal or a cooler configured to change cooling intensity based on the temperature control signal.

In an embodiment, the control circuit is configured to determine the target temperature based on at least one of a user input, an exterior temperature, a type of a substance, a cartridge parameter of a cartridge storing the substance, or user interaction data.

One aspect of the embodiments herein relates to a haptic-enabled dispenser for dispensing a consumable substance. The haptic-enabled dispenser comprises a housing having a passage and configured to dispense the consumable substance via the passage to an outlet in at least one portion of the passage. The haptic-enabled dispenser further comprises a haptic output device configured to generate a haptic effect. The haptic-enabled dispenser further comprises a user input component configured to receive a user input. The haptic-enabled dispenser further comprises a control circuit configured to determine a haptic setting based on the user input received via the user input component, and control the haptic output device to generate a haptic effect based on the haptic setting.

In an embodiment, the haptic-enabled dispenser further comprises a conversion component configured to convert the second substance to the consumable substance.

In an embodiment, the user input component comprises at least one of a mechanical button, a mechanical switch, a touch-sensing button, a touch surface, or a touch screen.

One aspect of the embodiments herein relates to a haptic-enabled dispenser for dispensing a consumable substance. The haptic-enabled dispenser comprises a housing having a passage and configured to dispense the consumable substance via the passage to an outlet in at least one portion of the passage. The haptic-enabled dispenser further comprises a plurality of electrodes disposed at different respective regions of an outer surface of the housing. The haptic-enabled dispenser further comprises a control circuit configured to control the plurality of electrodes to provide an electrical haptic effect.

In an embodiment, the haptic-enabled dispenser further comprises a conversion component configured to convert the second substance to the consumable substance.

In an embodiment, the control circuit is configured to select a subset of the plurality of electrodes for generating the haptic effect.

In an embodiment, the electrical haptic effect is at least one of an electrotactile stimulus effect or an electrostatic friction effect.

In an embodiment, one or more electrodes of the plurality of electrodes are disposed at the outlet.

One aspect of the embodiments herein relates to a haptic-enabled dispenser for dispensing a consumable substance. The haptic-enabled dispenser comprises a housing having a passage and configured to dispense the consumable substance via the passage to an outlet in at least one portion of the passage. The haptic-enabled dispenser further comprises a flow regulator disposed within the passage and configured to regulate a flow of the consumable substance to the outlet. The haptic-enabled dispenser further comprises a control circuit configured to control the flow regulator to generate a haptic effect by regulating the flow of the consumable substance to the outlet.

In an embodiment, the haptic-enabled dispenser further comprises a conversion component configured to convert the second substance to the consumable substance.

In an embodiment, the control circuit is configured to control the flow regulator based on at least one of user interaction data, user input, a cartridge parameter, or a type of the substance.

In an embodiment, the control circuit is configured to determine a type of the consumable substance, control the flow regulator to provide a first flow rate for the flow of the consumable substance when the type of the consumable substance is a first type, and control the flow regulator to provide a second flow rate for the flow of the consumable substance when the type of the consumable substance is a second type, the second flow rate being lower than the first flow rate.

In an embodiment, the flow regulator comprises a valve, and the control circuit is configured to control opening of the valve to control the flow of the consumable substance to the outlet.

In an embodiment, the flow regulator comprises a paddlewheel disposed in the passage, and a braking component configured to controllably provide resistance against motion of the paddlewheel, wherein the control circuit is configured to control an amount of the resistance to the motion of the paddlewheel.

In an embodiment, the haptic-enabled dispenser further comprises a flow sensor configured to sense a flow rate of the consumable, and wherein the control circuit is configured control the flow of the consumable substance based on the number of rotations.

In an embodiment, the haptic-enabled dispenser further comprises a user interaction component configured to generate user interaction data indicating user interaction with the haptic-enabled dispenser, wherein the control circuit is configured to control the flow of the consumable substance based on the user interaction data. In an embodiment, the user interaction component is disposed at the outlet of the housing, and wherein the user interaction that the user interaction component is configured to detect may comprise user intake of the consumable substance. In an embodiment, the user interaction that the user interaction component is configured to detect may comprise at least one of an amount of the consumable substance being consumed by a user or a duration of the user consumption of the consumable substance.

One aspect of the embodiments herein relates to a method of generating a haptic effect on a haptic-enabled dispenser for dispensing a consumable substance is provided. The method may be performed by a control circuit of the haptic-enabled dispenser. The method comprises sensing, via a user consumption sensor of the haptic-enabled dispenser, user consumption of a consumable substance from the haptic-enabled dispenser. The method further comprises determining a consumption quantity based on the sensing of the user consumption. The method further comprises determining whether the consumption quantity has reached or exceeded a defined consumption threshold. The method further comprises determining whether to provide a haptic effect at the consumption haptic-enabled dispenser, based on determining whether the consumption quantity has reached or exceeded the consumption threshold.

In an embodiment, the consumption quantity includes at least one of a number of consumption events, a consumption duration, or an amount of consumption of the consumable sub stance.

In an embodiment, the method further comprises determining a type of the consumable substance, wherein the determining whether to provide the haptic effect is based on the type of the consumable substance.

In an embodiment, the method further comprises, when the type of the consumable substance is a first type, generating a first control signal to provide a first haptic effect at the haptic-enabled dispenser, in response to determining that the consumption quantity has reached or exceeded the consumption threshold. In such an embodiment, the method further comprises determining an excess consumption quantity indicating how much the consumption quantity has exceeded the consumption threshold, in response to determining that the consumption quantity has exceeded the consumption threshold, and adjusting the first haptic effect based on the excess consumption quantity. In an embodiment, the adjusting the first haptic effect comprises increasing at least one of intensity of the first haptic effect or a duration of the first haptic effect as the excess consumption quantity increases. In an embodiment, the first haptic effect is provided by providing at least one of a vibration or an electrical stimulus.

In an embodiment, the method further comprises, when the type of the consumable substance is a second type, generating a second control signal to provide a second haptic effect at the haptic-enabled dispenser, in response to determining that the consumption quantity has neither reached nor exceeded the consumption threshold. In such an embodiment, the method further comprises refraining from generating the second control signal for providing the second haptic effect at the haptic-enabled dispenser, in response to determining that the consumption quantity has reached or exceeded the consumption threshold. In an embodiment, the method further comprises generating a first control signal to provide a first haptic effect at the haptic-enabled dispenser, in response to determining that the consumption quantity has exceeded the consumption threshold. In an alternative embodiment, the method further comprises generating a first control signal to provide a first haptic effect at the haptic-enabled dispenser, in response to determining that the consumption quantity has reached or exceeded a second consumption threshold that is greater than the consumption threshold.

In an embodiment, sensing the user consumption comprises at least one of sensing a flow of the consumable substance through the haptic-enabled dispenser or sensing a reservoir level of the consumable substance held by the haptic-enabled dispenser. In such an embodiment, the flow is sensed via a paddlewheel disposed in a passage of the flow within the haptic-enabled dispenser, the flow being sensed based on a number of rotations of the paddlewheel.

In an embodiment, the consumption threshold is set by at least one of a user input to the haptic-enabled dispenser, a manufacturer setting of the haptic-enabled dispenser, or communication with an external device.

In an embodiment, the consumption threshold is set to change over time.

One aspect of the embodiments herein relates to a method of generating a haptic effect on a haptic-enabled dispenser for dispensing a consumable substance. The haptic-enabled dispenser is configured to receive a cartridge storing the consumable substance. The method comprises determining a value of a cartridge parameter that provides information on the cartridge received by the haptic-enabled dispenser. The method further comprises determining that a haptic effect is to be generated at the haptic-enabled dispenser. The method further comprises determining a value of a haptic parameter of the haptic effect based on the cartridge parameter. The method further comprises controlling a haptic output device of the haptic-enabled dispenser to provide the haptic effect at the haptic-enabled dispenser with the value of the haptic parameter.

In an embodiment, the value of the cartridge parameter is determined by reading cartridge information on the cartridge.

In an embodiment, the cartridge parameter indicates at least one of: a type of a substance stored in the cartridge, a type of the cartridge, a size of the cartridge, a manufacturer of the cartridge, a manufacturer of the substance stored in the cartridge, an amount of the substance stored in the cartridge, or a cartridge safety status.

In an embodiment, the cartridge parameter comprises the cartridge safety status and wherein the determining the value of the cartridge parameter comprises at least one of determining whether the cartridge is recognized by the haptic-enabled dispenser, or determining whether the cartridge is malfunctioning.

In an embodiment, wherein the type of the substance indicated in the cartridge parameter is a tobacco product or a cannabis product, and wherein the haptic effect includes at least one of heat or vibration. In such an aspect, the haptic effect is provided with a light and a sound during each consumption.

One aspect of the embodiments herein relates to a method of generating haptic effects on haptic-enabled dispenser for dispensing a consumable substance. The method comprises retrieving, via a communication interface of the haptic-enabled dispenser, a haptic track from a device separate from the haptic-enabled dispenser, wherein the haptic track includes a haptic drive signal for driving a haptic output device of the haptic-enabled dispenser. The method further comprises storing the haptic track in an memory device of the haptic-enabled dispenser. The method further comprises determining that a haptic effect is to be generated at the haptic-enabled dispenser. The method further comprises reading the haptic track from the memory device and controlling the haptic output device to generate the haptic effect with the haptic track, in response to the determination that the haptic effect is to be generated.

In an embodiment, the method further comprises receiving, via an input device of the haptic-enabled dispenser, an input, and performing at least one of modifying the haptic track based on the input or generating a new haptic track based on the input.

In an embodiment, the method further comprises transmitting, via the communication interface, at least one of the modified haptic track or the new haptic track.

One aspect of the embodiments herein relates to a method of generating a haptic effect on a haptic-enabled dispenser for dispensing a consumable substance. The method comprises detecting, by an input sensor, a user touch on the haptic-enabled dispenser. The method further comprises identifying a gesture based on the detection of the user touch. The method further comprises controlling a haptic output device to provide a haptic effect based on the identified gesture.

In an embodiment, the identified gesture includes at least one of: turning the haptic-enabled dispenser with fingertips, sliding along the haptic-enabled dispenser with fingers, wrapping around the haptic-enabled dispenser with a hand, holding the haptic-enabled dispenser between fingers.

One aspect of the embodiments herein relates to a method of generating a haptic effect on a haptic-enabled dispenser for dispending a consumable substance. The method comprises retrieving, via an environment sensor, environment information including information on an environment surrounding the haptic-enabled dispenser. The method further comprises controlling a haptic output device to provide a haptic effect based on the environment information.

In an embodiment, the environment information includes at least one of sound information, brightness information, temperature information, weather information, location information, or speed information.

In an embodiment, the environment information is sound information including music. In such an embodiment, retrieving the environment information comprises retrieving at least one of an audio signal of the music or haptic information associated with the music, and generating a control signal for the haptic output device to provide the haptic effect based on at least one of the audio signal or the haptic information.

### BRIEF DESCRIPTION OF THE DRAWINGS

The foregoing and other features, objects and advantages of the invention will be apparent from the following description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 depicts a block diagram of a haptic-enabled dispenser for dispensing a consumable sub stance.

FIGS. 2A-2E depict block diagrams haptic-enabled dispensers for dispensing a consumable substance, according to embodiments hereof.

FIGS. 3A-3D depict haptic-enabled dispensers for dispensing a consumable substance, according to embodiments hereof.

FIGS. 4A and 4B depict use of a paddlewheel as a flow regulator for a haptic-enabled dispenser for dispensing a consumable substance.

FIGS. 5A and 5B depict use of a valve as a flow regulator for a haptic-enabled dispenser for dispensing a consumable substance.

FIGS. 6A-6C depict implementations for a haptic output device at a mouthpiece of a haptic-enabled dispenser for dispensing a consumable substance, according to embodiments hereof.

FIG. 7 depicts an example electronic vaping device, according to an embodiment of a haptic-enabled dispenser for dispensing a consumable substance.

FIG. 8 provides a flow diagram that illustrates steps of a method for generating a haptic effect on a haptic-enabled dispenser for dispensing a consumable substance, according to an embodiment hereof

FIG. 9 provides a flow diagram that illustrates steps of a method for generating a haptic effect on a haptic-enabled dispenser for dispensing a consumable substance, according to an embodiment hereof

FIG. 10 provides a flow diagram that illustrates steps of a method for generating a haptic effect on a haptic-enabled dispenser for dispensing a consumable substance, according to an embodiment hereof

FIG. 11 provides a flow diagram that illustrates steps of a method for generating a haptic effect on a haptic-enabled dispenser for dispensing a consumable substance, according to an embodiment hereof

FIG. 12 provides a flow diagram that illustrates steps of a method for generating a haptic effect on a haptic-enabled dispenser for dispensing a consumable substance, according to an embodiment hereof.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Embodiments described herein relate to a haptic-enabled dispenser for dispensing a consumable substance and a method of utilizing the haptic-enabled dispenser, where the haptic-enabled dispenser is used to dispense a consumable substance to a user such that the user may inhale and/or ingest the consumable substance. More specifically, haptic effects may be implemented to provide various features and to improve user experience with the haptic-enabled dispenser.

More particularly, in an aspect, some embodiments herein relate to a haptic-enabled dispenser for dispensing a consumable substance with improved structures and/or hardware components that can provide haptic effects to enhance user experience. Thus, the haptic-enabled dispenser may include a component to provide a haptic effect and a control circuit to control the provision of the haptic effect. The haptic-enabled dispenser may include a housing to store the consumable substance. A housing according to one example may directly store the consumable substance or a pre-consumable substance convertible to the consumable substance within the housing, while a housing according to another example may be configured to hold a cartridge storing the consumable substance or the pre-consumable substance convertible to the consumable substance that can be transferred to the housing. To dispense the consumable substance, the haptic-enabled dispenser may include a housing with a passage for the consumable substance such that the consumable substance may be dispensed through the passage to an outlet located at a portion of the passage, where a user may consume the consumable substance dispensed through the outlet. The haptic effects may include a vibrotactile effect, thermal effect (e.g., heating or cooling effect), electrical stimulus (e.g., electrotactile effect), a friction effect (e.g., electrostatic friction effect), a pressure effect (e.g., pressure effect), a resistance, etc. The haptic-enabled dispenser may additionally implement non-haptic effects related to at least one of a visual effect, an audio effect, smell, or taste, which may be paired with the haptic effect.

In an embodiment, the haptic-enabled dispenser may implement a haptic output device at an outlet of the haptic-enabled dispenser, where a user may consume (e.g., ingest/inhale) the consumable substance via the outlet. For example, a user may place lips or a mouth of the user at the outlet to inhale and/or ingest the consumable substance from the haptic-enabled dispenser. In such an example, as the user consumes the consumable substance from the haptic-enabled dispenser, a haptic effect may be provided at or near the lips and/or the mouth touching the outlet and thus the user may feel the haptic effect effectively.

In an embodiment, the haptic-enabled dispenser for dispensing a consumable substance may implement a temperature regulator that can provide a heating effect or a cooling effect as a haptic effect. In such an embodiment, the haptic-enabled dispenser may also include a temperature sensor to sense a temperature of one or more portions of the haptic-enabled dispenser. Based on the temperature sensed, the temperature regulator may provide a heating effect or a cooling effect to reach a target temperature. For example, by regulating the temperature of one or more portions of the haptic-enabled dispenser, the haptic-enabled dispenser may maintain the temperature of the consumable substance to a temperature that is suitable for human consumption. Additionally, the temperature regulator may be used to provide a heating effect or a cooling effect as a haptic effect that indicates a status (e.g., reservoir level of the consumable substance) or a notification. One example of the temperature regulator may be a thermoelectric device that can be used to provide heating or cooling. Another example of the temperature regulator may be a heater that may also be used to convert a pre-consumable substance to the consumable substance (e.g., vapor) via atomization.

In an embodiment, the haptic-enabled dispenser for dispensing a consumable substance may implement a user input component that may be used to receive user input to configure haptic effects provided at the haptic-enabled dispenser. The haptic effects may be provided based on haptic settings that can be configured by user input. For example, the user may use the user input component to enter a user input to configure haptic settings, such that the user may be able to customize the haptic effects provided by the haptic-enabled dispenser, thereby enhancing user experience. Examples of the user input component may include at least one of a mechanical button, a mechanical switch, a touch-sensing button, a touch-sensing surface, or a touch screen.

In an embodiment, the haptic-enabled dispenser for dispensing a consumable substance may implement electrodes to generate an electrical haptic effect, where the electrodes are located at different regions on the haptic-enabled dispenser. The electrical haptic effect may be an electrotactile stimulus effect. For example, if the electrodes are located at different regions, the electrodes may provide haptic effects for different purposes or different effects for different regions. Thus, for example, a subset of electrodes may provide a haptic effect in one region (e.g., at the outlet of the haptic-enabled dispenser) while another subset of electrodes may provide another haptic effect in another region (e.g., at a region used to hold the haptic-enabled dispenser).

In an embodiment, the haptic-enabled dispenser for dispensing a consumable substance may include a flow regulator within the passage of the haptic-enabled dispenser to regulate a flow of the consumable substance through the passage to the outlet of the haptic-enabled dispenser. A haptic effect may be generated by regulating the flow of the consumable substance to the outlet. For example, the user may be able to perceive differences in different flow rates of the consumable substance, thereby feeling different haptic effects depending on the flow rates provided by the flow regulator. In an aspect, the flow regulator may be controlled to provide different flow rates depending on types of the consumable substance or user preferences. For example, when dispensing a vapor as the consumable substance, a slow flow rate may be used to provide a slow pull sensation of a cigar when the substance is based on an unprocessed tobacco, whereas a faster flow rate may be used to provide a faster pull sensation of a cigarette when the substance is based on a processed tobacco similar to a cigarette. In an aspect, the flow regulator may be a valve, where opening or closing of the valve may be controlled to control the flow. In an aspect, the flow regulator may be a paddlewheel, where the motion of the paddlewheel may be controlled to control the flow. The haptic-enabled dispenser may include a sensor to generate user interaction data that indicates user interaction with the haptic-enabled dispenser, where the flow of the consumable substance may be based on the user interaction data. For example, the user interaction data may be associated with user intake of the consumable substance, such as an amount of the consumable substance consumed by a user and a duration of user consumption of the consumable substance.

Some embodiments herein relate to a method of generating a haptic effect on the haptic-enabled dispenser for dispensing a consumable substance. The method may be performed by the control circuit of the haptic-enabled dispenser, where the control circuit may utilize various components of the haptic-enabled dispenser.

In an embodiment, the control circuit may determine whether to provide a haptic effect based on whether a consumption quantity of the consumable substance has reached or exceeded a consumption threshold. The consumption quantity may be determined based on sensing user consumption of the consumable distance (e.g., via a sensor) from the haptic-enabled dispenser. The consumption quantity may be based on a number of consumption events, a consumption duration, and/or an amount of consumption of the consumable substance. In an aspect, the provision of the haptic effect may be based on a type of the consumable substance. For a first type of the consumable substance, a first haptic effect may be provided when the consumption quantity has reached or exceeded the consumption threshold. For example, if the consumable substance is a substance such as tobacco that is harmful or is to be discouraged from consumption (e.g., based on health recommendations), the first haptic effect that is unpleasant to the user may be provided when the consumption quantity has reached or exceeded the consumption threshold, so as to discourage the user to consuming the substance.

For a second type of the consumable substance, a second haptic effect may be provided as long as the consumption quantity has not been reached or exceeded the consumption threshold. For example, if the consumable substance is a type that provides health benefits to the user such as a medicine or a therapeutic substance, the second haptic effect that is pleasant to the user may be provided to encourage the user consumption until the consumption quantity has reached or exceeded the consumption threshold. However, because too much consumption may not be beneficial, after reaching or exceeding the consumption threshold, the second haptic effect that is pleasant to the user may not be provided (e.g., to stop encouraging the user consumption). To discourage the user consumption of the second substance after exceeding the consumption threshold, the first haptic effect that is unpleasant to the user may be provided when the consumption quantity exceeds the consumption threshold. Alternatively, the first haptic effect that is unpleasant to the user may be provided after the user continues to consume the substance to a certain extent after the consumption threshold has reached. Thus, the first haptic effect unpleasant to the user may be provided after a second consumption threshold that is greater than the consumption threshold is reached or exceeded, so as to discourage the user from further consumption of the substance.

In an embodiment, a control circuit may control a haptic effect provided by the haptic-enabled dispenser for dispensing a consumable substance based on a cartridge parameter of a cartridge storing the consumable substance or a pre-consumable substance convertible to the consumable substance. The haptic-enabled dispenser may be configured to couple with the cartridge to receive the consumable substance from the cartridge. In an aspect, the cartridge parameter may be determined by reading information (e.g., a bar code or a chip) on the cartridge. The cartridge parameter of a cartridge may be one or more types of information on the cartridge, such as a type of a substance stored in the cartridge, a type of the cartridge, a size of the cartridge, a manufacturer of the cartridge, a reservoir level of the cartridge, or a cartridge safety status. In one example, the haptic effect may be provided to warn the user of safety issues if the cartridge safety status of the cartridge parameter indicates safety issues such as the cartridge being unrecognizable (e.g., as a safe cartridge for use) and malfunctioning of the cartridge. In one example, if the type of the substance indicated by the cartridge parameter is a tobacco product, the haptic effect may be controlled to provide heat and/or vibration to simulate sensation of cigarette heat and/or tactile sensation from smoking a cigarette. The intensity of the haptic effect (e.g., the temperature of the heat or intensity of vibration) may be adjusted based on a flow rate of the consumable substance through the haptic-enabled dispenser. A sound and/or a light may be additionally provided to further simulate the sensation of cigarette smoking.

In an embodiment, the haptic-enabled dispenser for dispensing a consumable substance may be configured to communicate data such as a haptic track with another separate device, via a communication interface of the haptic-enabled dispenser. The haptic track includes information on how to provide the haptic effect. For example, the haptic track may include a pattern of vibrations provided by the haptic output device. In an aspect, the haptic-enabled dispenser may receive, via the communication interface (e.g., wireless communication modem), a haptic track from another device, and provide the haptic effect based on the haptic track received. The haptic track received from another device may be modified at the haptic-enabled dispenser via user input, and/or a new haptic track may be generated at the haptic-enabled dispenser via user input. The modified haptic track or the newly-generated haptic track may be transmitted, via the communication interface, to another device.

In an embodiment, the haptic effect may be provided based on a user gesture that is identified by the haptic-enabled dispenser for dispensing a consumable substance and is specific to the haptic-enabled dispenser. Certain user gestures are more specific to the haptic-enabled dispenser due to the shape and/or size of the haptic-enabled dispenser. Thus, such user gestures may be utilized to control the haptic effect. The user gesture may be determined based on a detection of a user touch on the haptic-enabled dispenser. The user gesture may include turning the haptic-enabled dispenser with fingertips, sliding along the haptic-enabled dispenser with fingers, wrapping around the haptic-enabled dispenser with a hand, and/or holding the haptic-enabled dispenser between fingers.

In an embodiment, the haptic-enabled dispenser may consider environment information on an environment surrounding the consumer substance haptic-enabled dispenser, and provide a haptic effect based on the environment information. The environment information may include sound information, brightness information, temperature information, weather information, location information, and/or speed information. With a haptic effect based on the environment information, the user may be provided with more rich experience when the user is placed in a certain environment. For example, the haptic-enabled dispenser may sense, via an audio sensor (e.g., microphone), an audio signal of music playing near the haptic-enabled dispenser or may retrieve haptic information associated with the music, such that the haptic effect may be provided based on the audio signal or the haptic information.

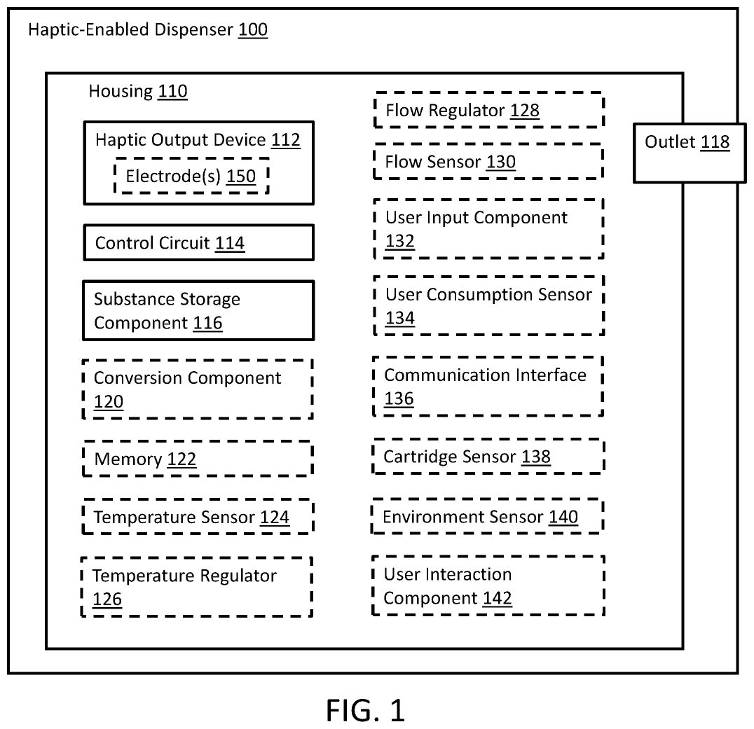

FIG. 1 illustrates a block diagram of a haptic-enabled dispenser 100 for dispensing a consumable substance having a housing 110, where the haptic-enabled dispenser 100 includes a haptic output device 112 configured to generate a haptic effect and a control unit 114 configured to control the haptic output device to generate the haptic effect. The components within the haptic-enabled dispenser 100 illustrated with dotted line blocks may be optional components. The haptic-enabled dispenser 100 may be an electronic vaporizing device (e.g., vaping device), such as an e-cigarette, or any other haptic-enabled dispenser that is capable of dispensing a consumable substance for user consumption (e.g., ingestion/inhalation). In an embodiment, the haptic-enabled device 100 may further include a substance storage component 116, an outlet 118, a conversion component 120, a memory 122, a temperature sensor 124, a temperature regulator 126, a flow regulator 128, a flow sensor 130, a user input component 132, a user consumption sensor 134, a communication interface 136, a cartridge sensor 138, an environment sensor 140, and a user interaction component 142. The haptic output device 112 may include one or more electrodes 150. The memory 106 may be configured to store an electronic data such as a haptic track.

In an embodiment, the control circuit 114 may be configured to generate a control signal for the haptic output device 112 to generate a haptic effect. In the embodiment of FIG. 1, the control circuit 114 may be configured to generate the control signal by executing instructions stored in memory 122. The control circuit 114 may, in an embodiment, be implemented as one or more processors (e.g., a microprocessor), a field programmable gate array (FPGA), application specific integrated circuit (ASIC), programmable logic array (PLA), or other control circuit. The control circuit 114 may be part of a general purpose control circuit for the haptic-enabled dispenser 100, such as a processor for executing an operating system or for implementing other functionality of the haptic-enabled device, or the control circuit 114 may be a control circuit dedicated to controlling haptic effects. In an embodiment, the control circuit 114 may include any amplifier circuit, any digital to analog converter (DAC), or any other circuit for creating a drive signal that can drive the haptic output device 112.

In an embodiment, the substance storage component 116 may be configured to store a substance, where the substance may be a consumable substance and/or a pre-consumable substance convertible to a consumable substance (e.g., via the conversion component 120). For example, the substance storage component 116 may have a storage reservoir to directly store the substance, and/or may be configured to couple with a cartridge storing the substance. If the substance is a consumable substance, the haptic-enabled dispenser 100 may receive the substance from the substance storage component 116 via a passage through the housing 110. If the substance is a pre-consumable substance convertible to a consumable substance, the conversion component 120 may receive the substance from the substance storage component 116 and convert the substance to the consumable substance, such that the consumable substance may be dispensed toward the outlet 118 via a passage through the housing 110. In some instances, the conversion component 120 may be a part of a cartridge that can be coupled to the substance storage component 116. In such instances the substance in the cartridge may be converted to the consumable substance and the consumable substance may travel to the passage through the housing 110 toward the outlet 118.

In an embodiment, the haptic output device 112 may be a standard-definition (SD) haptic output device and/or a high-definition (HD) haptic output device. The SD haptic output device may include an actuator (e.g., eccentric rotating mass (ERM) actuator) that is designed to be driven with a DC signal, or an actuator (e.g., linear resonant actuator (LRA)) designed to be driven at only a single frequency. The HD haptic output device may include a piezoelectric actuator, electroactive polymer (EAP) actuator, any other smart material actuator, or a wideband LRA. The piezoelectric actuator, EAP actuator, and wideband LRA may each be designed to be driven in a range of frequencies having a nonzero bandwidth, i.e., a bandwidth that is greater than a single frequency, and may each have a structure that supports a nonzero acceleration bandwidth for motion of that structure. In some instances, the HD haptic output device may include an ERM actuator that is designed to be driven with an alternating current (AC) signal, and is further designed to be driven in a range of frequencies having a nonzero bandwidth. In such an example, the ERM actuator may further have a nonzero acceleration bandwidth. In an embodiment, a haptic output device 112 may include a vibrotactile haptic actuator configured to generate a haptic effect. In an embodiment, a haptic output device 112 may include an ultrasound emitter configured to generate an ultrasound-based haptic effect. In an embodiment, a haptic output device 112 may have a single resonant frequency or multiple resonant frequencies. In an embodiment, a haptic output device 112 may have no resonant frequency. In an embodiment, the haptic output device 112 may include one or more electrodes for providing electrical stimulus such as electrotactile stimulus as a haptic effect or for providing a friction effect such as an electrostatic friction effect. In an embodiment, a haptic output device 112 may provide a haptic effect by deformation.

In an embodiment, the memory 106 may be a non-transitory computer-readable medium, and may include read-only memory (ROM), random access memory (RAM), a solid state drive (SSD), a hard drive, or other type of memory. In FIG. 1, the memory 106 may store a haptic track and instructions that can be executed by the control circuit 114 to generate a control signal according to an embodiment herein. In an embodiment, the memory 106 may store other information and/or modules.

In an embodiment, the temperature sensor 124 may be configured to sense a temperature at one or more portions of the haptic-enabled dispenser 100. In some instances, the temperature sensor is configured to sense an interior temperature of the haptic-enabled dispenser 100, such as a temperature within a passage from the substance storage component 116 to the outlet 118.

In an embodiment, the temperature regulator 126 may be configured to change a temperature within the housing 110 by providing heating and/or cooling. The heating effect or the cooling effect provided by the temperature regulator 126 may be considered as a haptic effect sensed by a user. Therefore, in some instances, the temperature regulator 126 may be considered a part of the haptic output device 122.

In an embodiment, the flow regulator 128 may be configured to regulate a flow of the consumable substance to the outlet 118. In an aspect, the flow regulator 128 may be configured to change a flow rate of the consumable substance to the outlet 118. Because a user may sense different flow rates, the flow regulator 128 may provide a haptic effect by providing different flow rates. Therefore, in some instances, flow regulator 128 may be considered a part of the haptic output device 122.

In an embodiment, the flow sensor 130 may be configured to sense a flow of the consumable substance to the outlet 118. In an aspect, the flow sensor 130 may be configured to sense a flow rate of the consumable substance. For example, the flow sensor 130 may be a paddlewheel, magnetic-field based device, and/or an infrared/ultrasound based device. In an embodiment, a haptic effect may be adjusted based on the flow rate sensed by the flow sensor 130.

In an embodiment, the user input component 132 may be configured to receive an input from a user. Examples of the user input component 132 may include a mechanical button, a mechanical switch, a touch-sensing button, a touch surface (e.g., touch pad), a touch screen, or any other device capable of receiving an input from a user.

In an embodiment, the user consumption sensor 134 may be configured to sense user consumption of the consumable substance. In one example, the user consumption sensor 134 may be a sensor that senses a suction pressure applied at the outlet 118 by a user to consume the consumable substance via the outlet 118. The control circuit 114 may gather information from the user consumption sensor 134 and the flow sensor 130 to determine a consumption quantity of the consumable substance. In another example, the user consumption sensor 134 may be the flow sensor 130, where the control circuit 114 may determine that user consumption is occurring when a flow of the consumable substance is sensed by the flow sensor 130.

In an embodiment, the communication interface 136 may be configured to communicate with another device, such as a desktop computer, or with a network, such as the Internet. The communication interface 103 may be used, for instance, to receive (e.g., download) a haptic track from another device or from a network and/or to transmit a haptic track to another device or a network. The communication interface 136 may include a wireless communication interface for wireless communication (e.g., via wireless local area network (WLAN) connection, Bluetooth, telecommunication, etc.) and/or a wired communication interface (e.g., local area network connection (LAN), etc.).

In an embodiment, the cartridge sensor 138 may be configured to sense various cartridge parameter values from a cartridge coupled to the substance storage component 116, where the cartridge stores a consumable substance or a pre-consumable substance convertible to a consumable substance. Examples of the cartridge sensor 138 may include a bar code reader, a chip reader, an optical sensor, etc. A haptic effect may be provided based on the cartridge parameter value(s) sensed by the cartridge sensor 138.

In an embodiment, the environment sensor 140 may be configured to sense environment information on an environment surrounding the haptic-enabled dispenser 100, such that a haptic effect may be provided based on the environment information. For example, the environment sensor 140 may be configured to sense one or more of sound information, brightness information, temperature information, weather information, location information, and/or speed information.

In an embodiment, the user interaction component 142 may be configured to generate user interaction data indicating user interaction with the haptic-enabled dispenser 100, such that a haptic effect may be provided based on the user interaction data. The user interaction data may include information associated with user interactions with the haptic-enabled dispenser 100. Thus, user interaction component 142 may be configured to gather information on user interactions from various components in the haptic-enabled dispenser 100, and may generate the user interaction data.

In an embodiment, the haptic-enabled dispenser 100 may be a portable device or a wearable device. In an embodiment, the haptic-enabled dispenser 100 may be a part of a mobile device (e.g., mobile phone) or may be a part of a wearable device (e.g., smart watch).

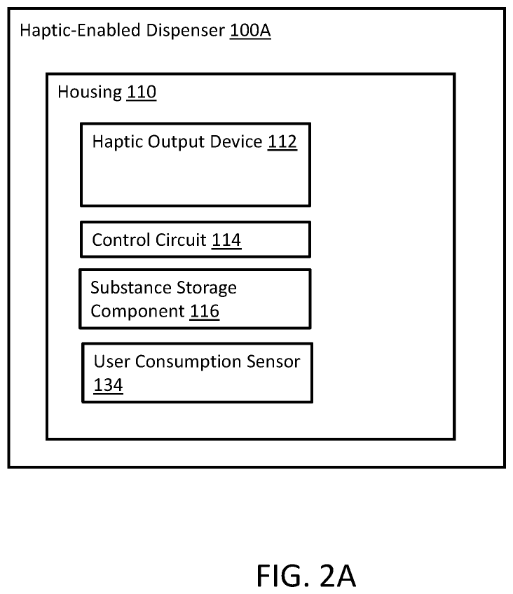

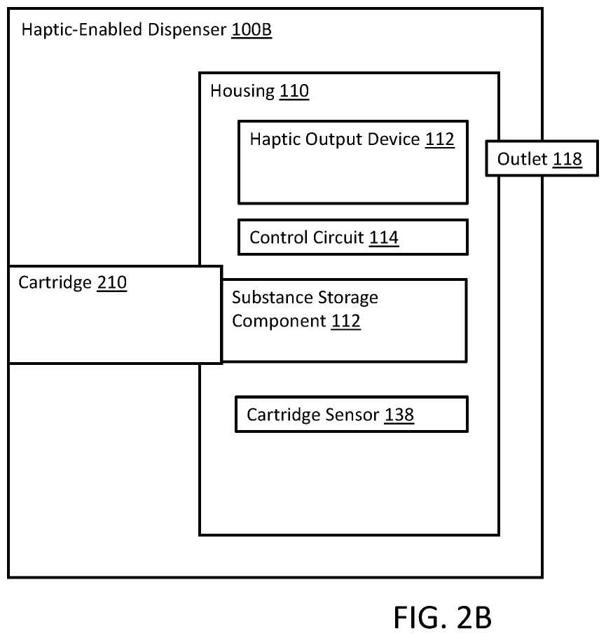

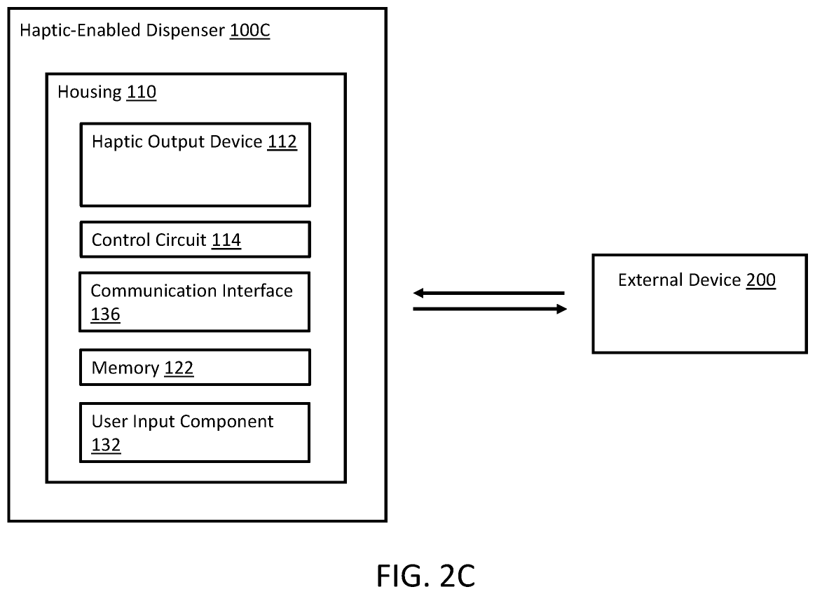

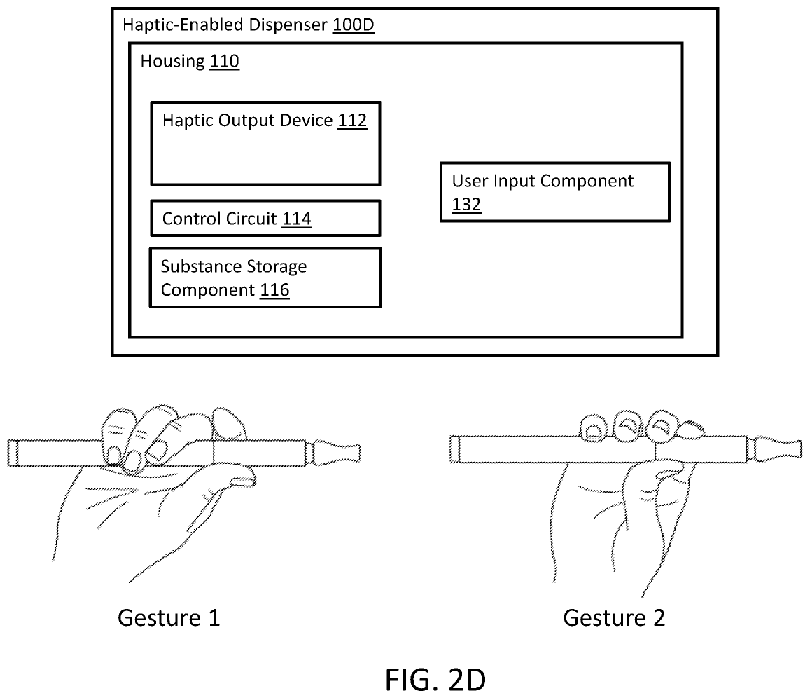

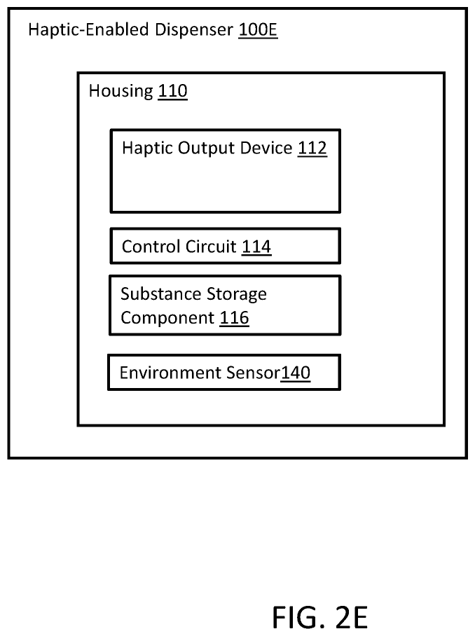

FIGS. 2A-2E illustrate various embodiments of the haptic-enabled dispenser 100 for dispensing a consumable substance according to various aspects of the disclosure. In some instances, two or more of the aspects of the disclosure described below in relation to FIGS. 2A-2E may be combined. FIG. 2A illustrates an embodiment 100A of the haptic-enabled dispenser 100 that may provide a haptic effect based on user consumption of the consumable substance. For example, for one type of a substance, because excess consumption of a substance may be harmful to a user, it may be beneficial to provide a haptic effect that discourages a user from excess consumption. In another example, for another type of substance, a substance such as medication or a therapeutic substance may provide benefits to a user, and thus a haptic effect that encourages a user to consume such a substance may be beneficial. To determine whether to provide a haptic effect based on user consumption, the control circuit 114 may sense, via the user consumption sensor 134, user consumption of the consumable substance from the haptic-enabled dispenser 100A, determine a consumption quantity based on the sensing of the user consumption, and determine whether consumption quantity has reached or exceeded a defined consumption threshold. Then, based on determining whether the consumption quantity has reached or exceeded the consumption threshold, the control circuit 114 may determine whether to provide a haptic effect at the consumption haptic-enabled dispenser. The consumption quantity may be defined by one or more of a number of consumption events, a consumption duration, and an amount of consumption of the consumable substance.

Because provision of a haptic effect may be different based on a type of the consumable substance, the control circuit 114 may determine a type of the consumable substance, such that the control circuit 114 may determine whether to provide the haptic effect, based on the type of the consumable substance. In an aspect, when the type of the consumable substance is a first type, in response to determining that the consumption quantity has reached or exceeded the consumption threshold, the control circuit 114 may generate a first control signal to provide a first haptic effect at the haptic-enabled dispenser 100A. For example, if the first type is a substance that can be harmful to a user with continued consumption, such as a tobacco product having nicotine, the control circuit 114 may send a first control signal to the haptic output device 112 to provide a first haptic effect that may discourage a user from further consumption when the consumption quantity has reached or exceeded the consumption threshold. Thus, the control circuit 114 may be capable of providing a negative hedonic response with the first haptic effect to discourage excess consumption of a certain type of substance. The first haptic effect may be an unpleasant haptic effect, such as a vibration in a high frequency (e.g., 170 Hz or above), an electrical stimulus that may be unpleasant to the user, high heat, etc. The unpleasant haptic effect may be accompanied by an unpleasant noise (e.g., high pitched noise) or light.

In an aspect, in response to determining that the consumption quantity has exceeded the consumption threshold, the control circuit 114 may determine an excess consumption quantity indicating how much the consumption quantity has exceeded the consumption threshold, and adjust the first haptic effect based on the excess consumption quantity. In an aspect, the control circuit 114 may adjust the first haptic effect by increasing at least one of intensity of the first haptic effect or a duration of the first haptic effect as the excess consumption quantity increases. For example, if a user continues to consume the consumable substance of the first type even after reaching the consumption threshold, the control circuit 114 may increase the intensity of the first haptic effect and/or a duration of the first haptic effect to make the first haptic effect more unpleasant and to discourage the user consumption even more.

In another aspect, when the type of the consumable substance is a second type, in response to determining that the consumption quantity has neither reached nor exceeded the consumption threshold, the control circuit 114 may generate a second control signal to provide a second haptic effect at the haptic-enabled dispenser 100A. For example, if the consumable substance of the second type is a substance that is beneficial to a user, such as a medicinal or therapeutic product, the control circuit 114 may send a second control signal to the haptic output device 112 to provide a second haptic effect that may encourage consumption of the consumable substance until the consumption quantity has reached or exceeded the consumption threshold. Thus, the control circuit 114 may be capable of providing a positive hedonic response with the second haptic effect to encourage consumption of a certain type of substance. The second haptic effect may be a pleasant haptic effect, such as a gentle low intensity vibration and/or mild heat. However, excess consumption of the consumable substance of the second type may not be beneficial to the user and thus may not be encouraged. Hence, in response to determining that the consumption quantity has reached or exceeded the consumption threshold, the control circuit 114 may refrain from generating the second control signal for providing the second haptic effect at the haptic-enabled dispenser 100A. Further, a different haptic effect may be provided when the consumption threshold is reached or a higher consumption threshold is reached, e.g., in order to discourage the user from further consumption of the consumable substance. Hence, in one aspect, in response to determining that the consumption quantity has exceeded the consumption threshold, the control circuit 114 may generate a first control signal to provide a first haptic effect at the haptic-enabled dispenser 100A. In an alternative aspect, in response to determining that the consumption quantity has reached or exceeded a second consumption threshold that is greater than the consumption threshold, the control circuit 114 may generate the first control signal to provide the first haptic effect at the haptic-enabled dispenser 100A.

In an embodiment, the consumption threshold is set by at least one of a user input to the haptic-enabled dispenser 100A, a manufacturer setting of the haptic-enabled dispenser 100A, communication with an external device, or a manufacturer setting of the cartridge. In an aspect, the consumption threshold may be different for a different type of substance, at least because different substances may have different effects on a user. In an aspect, the consumption threshold may be set to change over time. For example, a user trying to quit a tobacco product may set the consumption threshold such that the consumption threshold is lowered over time. As the consumption threshold is lowered over time, the first haptic effect to discourage user consumption may be triggered with less consumption of the tobacco product over time, in order to help the user reduce the amount of tobacco product consumption over time.

FIG. 2B illustrates an embodiment 100B of the haptic-enabled dispenser 100 that may control a characteristic of a haptic effect based on a cartridge parameter of a cartridge storing a consumable substance. The haptic-enabled dispenser 100B may be configured to receive a cartridge 210 storing the consumable substance. For example, the substance storage component 112 may be configured to couple with the cartridge 210 to dispense the consumable substance to the outlet 118 via a passage. In an embodiment, the control circuit 114 may determine a value of a cartridge parameter that provides information on the cartridge 210 received by the haptic-enabled dispenser 110B (e.g., via the cartridge sensor 138). The value of the cartridge parameter is determined by reading cartridge information on the cartridge 210, e.g., via the cartridge sensor 138. For example, the cartridge 210 may include a bar code and/or a chip that indicates information on the cartridge parameter and can be read by the cartridge sensor 138 that includes a bar code reader and/or a chip reader. In one example, the cartridge 210 may include an optical sensor capable of reading a reservoir level of the cartridge 210 and/or a color of the substance stored in the cartridge 210. The control circuit 114 may determine that a haptic effect is to be generated at the haptic-enabled dispenser 110B, and then determine a value of a haptic parameter of the haptic effect based on the cartridge parameter. Subsequently, the control circuit 114 may control the haptic output device 112 of the haptic-enabled dispenser 100B to generate the haptic effect at the haptic-enabled dispenser 100B with the value of the haptic parameter.

The cartridge parameter may indicate one or more of: a type of a substance stored in the cartridge, a type of the cartridge, a size of the cartridge, a manufacturer of the cartridge, a manufacturer of the substance stored in the cartridge, an amount of the substance stored in the cartridge, or a cartridge safety status. For example, the type of the substance may indicate one or more of a name of the substance, a flavor of the substance, a color of the substance, etc. In an aspect, if the cartridge parameter includes the cartridge safety status, the control circuit 114 may determine the value of the cartridge parameter by determining whether the cartridge is recognized by the haptic-enabled dispenser and/or determining whether the cartridge is malfunctioning. If the cartridge is not recognized by the haptic-enabled dispenser and/or the cartridge is malfunctioning, the control circuit 114 may control the haptic output device 112 to provide the haptic effect with the value of the haptic parameter, e.g., where the value of the haptic parameter may be for a haptic effect to alert the user of safety issues. In an aspect, if the type of the substance indicated in the cartridge parameter is a tobacco product, the haptic effect may include at least one of heat or vibration, e.g., to simulate sensations from smoking a cigarette or a cigar or utilizing a bong, bubbler, or waterpipe. In such an aspect, the haptic effect may be additionally provided with a light and a sound during each consumption, e.g., to provide additional sensation associated with smoking a cigarette or a cigar or utilizing a bong, bubbler, or waterpipe. In another example, the haptic output device 112 may provide deformation-based haptic effect at the mouthpiece portion 320 based on the amount of the substance stored in the cartridge. For example, the haptic output device 112 may change a shape at a portion of the mouthpiece portion 320 based on the amount of the substance stored in the cartridge such that the user may be aware of the amount of the substance left in the cartridge as the user consumes the consumable substance through the outlet 118 at the mouthpiece portion 320.

FIG. 2C illustrates an embodiment 100C of the haptic-enabled dispenser 100 capable of communicating with a different device via the communication interface 136. In an embodiment, the control circuit 114 may retrieve, via the communication interface 136, a haptic track from the external device 200 separate from the haptic-enabled dispenser 100C, where the haptic track may include a haptic drive signal for driving the haptic output device 112. The control circuit 114 may store the haptic track in the memory device 122 of the haptic-enabled dispenser 100C. The control circuit 114 may determining that a haptic effect is to be generated at the haptic-enabled dispenser 100C. In response to the determination that the haptic effect is to be generated, the control circuit 114 may read the haptic track from the memory device 112 and may control the haptic output device 112 to generate the haptic effect with the haptic track. The external device 200 may be a mobile device, a computer, a cloud storage device, or another haptic-enabled dispenser.

In an embodiment, the control circuit 114 may receive, via the user input component 132, an input. Then, the control circuit 114 may modify the haptic track based on the input and/or may generate a new haptic track based on the input. In an aspect, the control circuit 114 may transmit, via the communication interface, at least one of the modified haptic track or the new haptic track. Because the haptic-enabled dispenser 100C is capable of communicating haptic tracks with the external device 200, user experience may be improved by providing a capability to enable sharing the haptic tracks with the external device 200. In one example, if the external device 200 is a server for a user community, a user may use the haptic-enabled dispenser 100C to share haptic tracks with other users in the user community. In one example, the external device 200 may store a calendar for the user, and the communication interface 136 may be used to receive a notification of events in the calendar, such that a haptic effect may be provided based on the notification received.

FIG. 2D illustrates an embodiment 100D of the haptic-enabled dispenser 100 capable of providing a haptic effect based on a user gesture associated with the haptic-enabled dispenser 100. In an embodiment, the control circuit may detect, via the user input component 132, a user touch on the haptic-enabled dispenser 100D, and may identify a gesture based on the detection of the user touch. Then, the control circuit 114 may control the haptic output device 112 to provide a haptic effect based on the identified gesture. Because certain gestures by a user may be specific to the haptic-enabled dispenser 100D, such gestures may be identified to be used as an input for controlling the haptic output device 112, to provide a convenient way for a user to control the haptic effect. In an aspect, the identified gesture may include at least one of: turning the haptic-enabled dispenser 100D with fingertips, sliding along the haptic-enabled dispenser 100D with fingers, wrapping around the haptic-enabled dispenser 100D with a hand (e.g., Gesture 1 of FIG. 2D), or holding the haptic-enabled dispenser 100D between fingers (e.g., Gesture 2 of FIG. 2D). For example, each gesture may be assigned to a specific control signal, such as adjusting an intensity of the haptic effect, activating or deactivating the haptic effect, selecting a different haptic effect, etc.

FIG. 2E illustrates an embodiment 100E of the haptic-enabled dispenser 100 configured to consider a surrounding environment to control a haptic effect. In an embodiment, the control circuit may retrieve, via the environment sensor 140, environment information including information on an environment surrounding the haptic-enabled dispenser 100E, and may control the haptic output device 112 to provide a haptic effect based on the environment information. The environment sensor 140 may be any sensing device configured to retrieve information about a surrounding environment, such as a temperature sensor, audio sensor (e.g., microphone), a light sensor, a speed sensor, a location sensor, a speed sensor, etc. With the haptic effect based on the environment information, the user may feel immersed in the environment. The environment information may include at least one of sound information, brightness information, temperature information, weather information, location information, or speed information.

In an aspect where the environment information is sound information including music, the control circuit 114 may retrieve the environment information by retrieving at least one of an audio signal of the music or haptic information associated with the music and generating a control signal for the haptic output device 112 to provide the haptic effect based on at least one of the audio signal or the haptic information. For example, the control circuit 114 may use an audio sensor (e.g., microphone) to sense an audio signal of music playing near the haptic-enabled device 100 and control the haptic output device 112 to provide the haptic feedback based on the audio signal. For example, the control circuit 114 may retrieve haptic information associated with music playing near the haptic-enabled device 100 (e.g., from the memory 122 or from another device via the communication interface 136), and may control the haptic output device 112 to provide the haptic feedback based on the haptic information.

In an aspect, the environment information may indicate a type of activity in which a user is participating. For example, the environment sensor 140 may retrieve environment information including speed information and/or location information to determine a type of activity, and may provide the haptic feedback accordingly. In one example, a gentle soothing haptic feedback may be provided if the environment information indicates a slow speed at a yoga studio, while an upbeat haptic feedback may be provided if the environment information indicates a fast speed on a road.

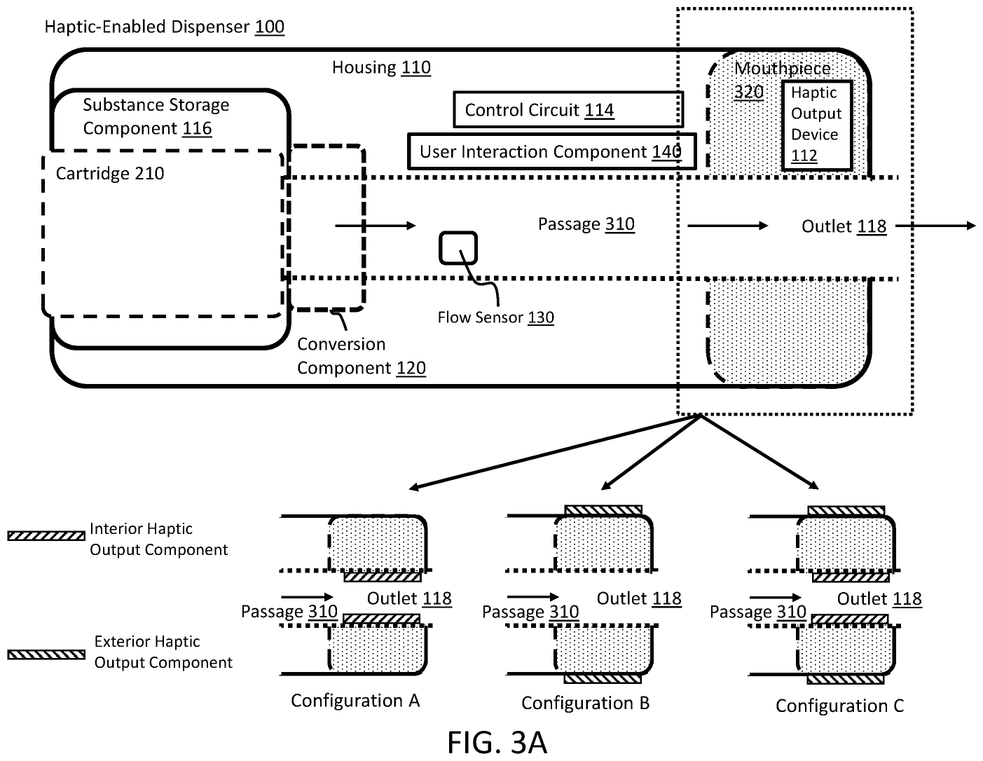

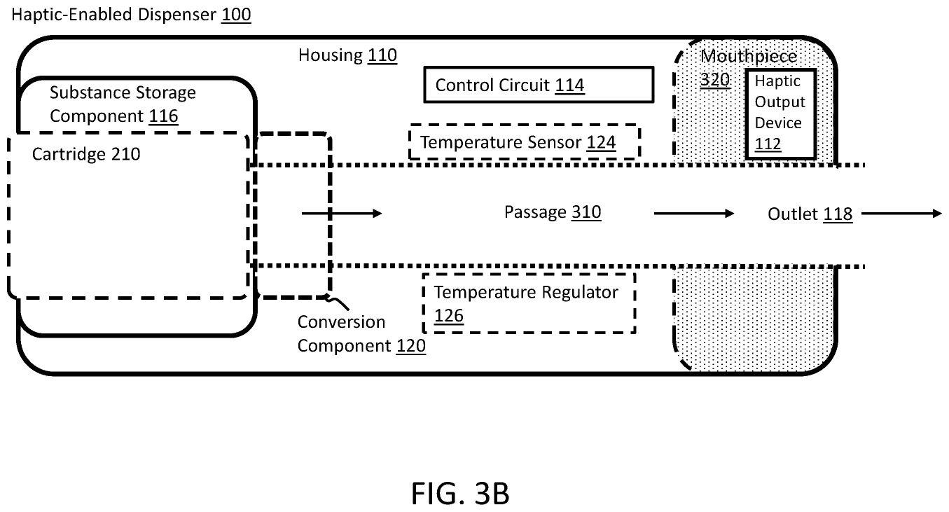

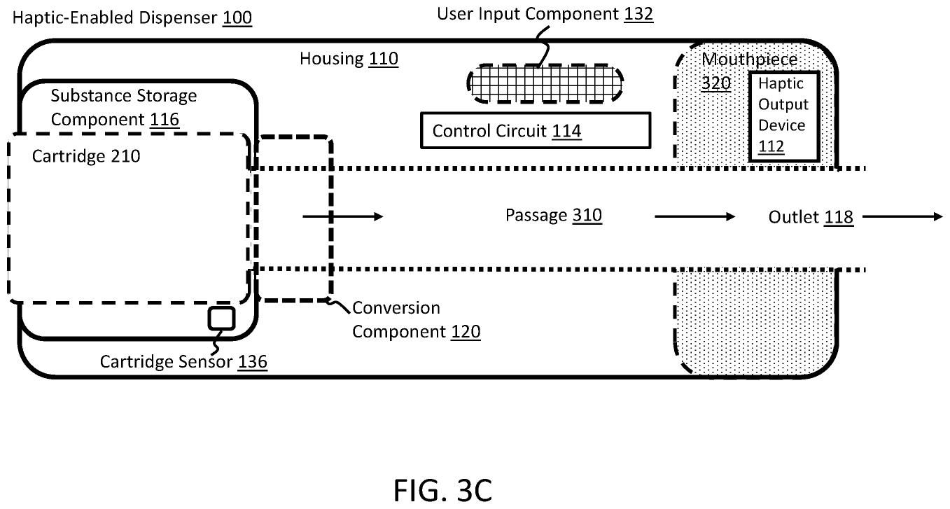

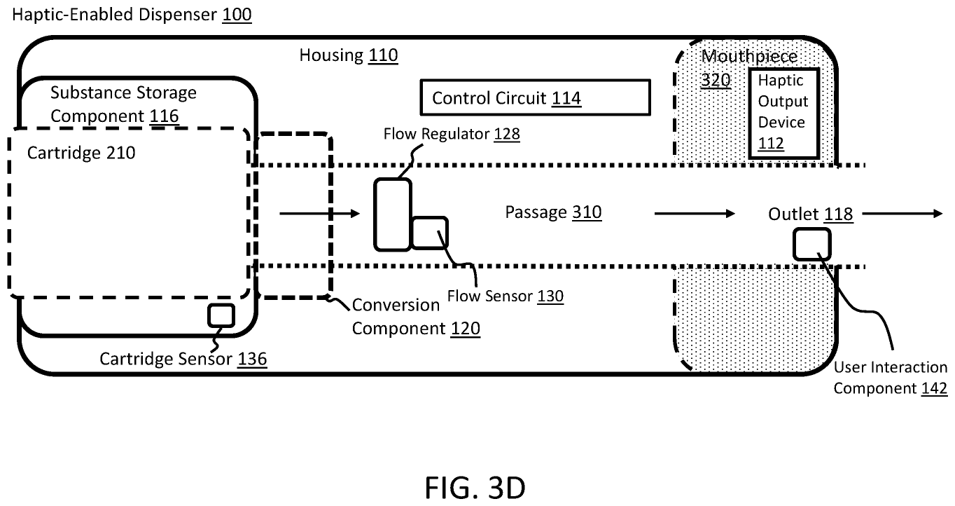

FIGS. 3A-3D illustrate a cross-sectional view of various aspects of the haptic-enabled dispenser 100 for dispensing a consumable substance according to one or more aspects of the disclosure. In FIGS. 3A-3D, the dotted blocks may represent components that may be optional components. In FIG. 3A, in an embodiment, the haptic-enabled dispenser 100 for dispensing a consumable substance includes the housing 110 having a passage 310, the haptic output device 112 and the control circuit 114. In some instances, the haptic-enabled dispenser 100 may further include a conversion component 120 configured to convert a pre-consumable substance to the consumable substance. For example, the conversion component 120 may be an atomizer that can convert a liquid to a consumable vapor. The substance storage component 116 may be used to store a consumable substance or a pre-consumable substance that is convertible to a consumable substance. In one embodiment, the substance storage component 116 may have a storage to directly store the consumable substance or the pre-consumable substance or may be configured to couple with a cartridge 210 that stores the consumable substance or the pre-consumable substance. In an aspect, the consumable substance may include at least one of an inhalable vapor, an inhalable aerosol, an ingestible liquid, or an ingestible solid.

As illustrated with the arrows, the housing 110 may be configured to dispense the consumable substance via the passage 310 to an outlet 118 located at the mouthpiece portion 320. The mouthpiece portion 320 of the housing 110 may be a portion where a user mouth may contact, directly or indirectly, to consume the consumable substance via the outlet 118. In an embodiment, the haptic output device 112 may be disposed at the mouthpiece portion 320. The control circuit 114 may be configured to control the haptic output device 112 to generate a haptic effect at the mouthpiece portion 320 of the housing 110 of the electronic consumable haptic-enabled dispenser 100. Providing a haptic effect near a portion where lips may touch during consumption of the consumable substance may be beneficial in that lips are sensitive areas of a human body that can effectively sense haptic effects. In an embodiment, the haptic output device 112 may be disposed in another portion of the housing 110. For example, the haptic output device 112 may be disposed a handle portion that can be grabbed by a user, such that the haptic effect by the haptic output device 112 may be sensed by a hand grabbing the handle portion.

In an embodiment, the haptic-enabled dispenser 100 may further include a user interaction component 140 configured to collect user interaction data including information on user interaction with the haptic-enabled dispenser 100. In such an embodiment, the control circuit 114 may be configured to control the haptic output device 112 to generate the haptic effect based on the user interaction data. The interaction data may include at least one of a dispensed amount of the consumable substance, user touch data, or a position data with respect to a user position and a position of the haptic-enabled dispenser 100. For example, a type and/or an intensity of the haptic effect may vary based on the interaction data to indicate a level of user interaction. In another example, a haptic effect setting for the haptic output device 112 may be adjusted based on the user interaction data.

In an embodiment, the haptic-enabled dispenser 100 may further include the memory 122 configured to store data and the communication interface 136 configured to perform data communication. The control circuit 114 may be configured to receive a haptic track from a separate device (e.g., external device 200) via the communication interface 136 and to store the haptic track on the memory 122, where the haptic output device 112 may generate the haptic effect based on the haptic track. As discussed above in relation to FIG. 2C, the communication interface 136 may improve user experience by providing a capability to enable sharing the haptic tracks with other devices, which may allow a user of the haptic-enabled dispenser 100 to share the haptic tracks with users of other devices.

One or more components may be implemented as a haptic output device 112 to provide the haptic effect. In an embodiment, the haptic output device 112 may include an actuator to provide a vibration as the haptic effect, at least one electrode disposed on a surface of the housing to provide electrical stimulus as the haptic effect, and/or a temperature regulator (e.g., temperature regulator 126) configured to change a temperature within the housing to generate the haptic effect, and/or a flow regulator (e.g., flow regulator 128) configured to regulate a flow of the substance through the passage to generate the haptic effect. Such components may be used to generate at least one of a vibrotactile effect, electrical stimulus effect (e.g., electrotactile effect), a thermal effect (e.g., thermoelectric effect), a friction effect (e.g., electrostatic friction effect), a pressure effect, or an ultrasonic effect.

In an embodiment, the housing 110 may have an interior wall that forms the passage 310. The haptic output device 112 may include an interior layer of an interior haptic output component directly disposed on the interior wall of the housing 110 at the passage 310 and/or an exterior layer of an exterior haptic output component disposed on an exterior of the housing 110, e.g., near a haptic portion where the haptic output device 112 provides the haptic output. In an embodiment, the haptic output device 112 may include an interior layer of an interior haptic output component directly disposed on the interior wall at the mouthpiece portion 320 and/or an exterior layer of an exterior haptic output component disposed on an exterior of the mouthpiece portion 320. As illustrated in FIG. 3A, for example, one of Configurations A, B, and C may be implemented to implement the interior haptic output component and/or the exterior haptic output component. More specifically, Configuration A implements an interior layer of the interior haptic output component on the interior wall at the mouthpiece portion 320. Configuration B implements an exterior layer of the exterior haptic output component on the exterior of the mouthpiece portion 320. Configuration C implements both the interior layer of the interior haptic output component and the exterior layer of the exterior haptic output component. In some instances, the interior haptic output component may include multiple interior haptic output components spaced apart from one another, and the exterior haptic output component may include a multiple exterior haptic output components spaced apart from one another, as discussed in more detail infra. In some instances, the interior haptic output component is configured to generate a first haptic effect and the exterior haptic output component is configured to generate a second haptic effect different from the first haptic effect.

In an embodiment, the haptic-enabled dispenser 100 may further include a flow sensor 130 to sense a flow rate of the consumable substance through the passage 310, where the control circuit 114 is further configured to control the haptic output device 112 to adjust an intensity of the haptic effect based on the flow rate of the consumable substance. In some instances, when a user consumes the consumable substance by applying a suction pressure in the passage 310, the control circuit 114 may control the haptic output device 112 to provide a more intense haptic effect for a higher flow rate of the consumable substance (e.g. due to higher suction force by the user). For example, when a sensation of a cigarette is simulated using the haptic output device 112, the haptic output device 112 may provide more vibration and/or more heat for a higher flow rate to simulate more crackling of a burning cigarette due to a stronger suction pressure by the user. In such an example, a sound may be provided to simulate the sound from crackling of a burning cigarette. For example, when a sensation of a bong or a hookah is simulated using the haptic output device 112, the haptic output device 112 may provide more vibration and/or more heat for a higher flow rate to simulate more bubbling of water within the bong or the hookah. In such an example, a sound may be additionally provided to simulate the bubbling sound within the bong or the hookah based on the flow rate.

In an embodiment, the haptic output device 112 may include electrodes disposed at different respective regions of an outer surface of the housing. In such an embodiment, the control circuit 114 may be configured to control the electrodes to provide an electrical haptic effect. The electrical haptic effect may be an electrotactile stimulus effect, such as a mild electric shock. In some instances, the control circuit 114 may be configured to select a subset of the electrodes for generating the haptic effect, instead of generating the haptic effect using all of the electrodes. In one example, one subset of the electrodes may be used to generate a first haptic effect while another subset of the electrodes may be used to generate a second haptic effect different from the first haptic effect. In some instances, one or more of the electrodes may be disposed at the outlet 118. For example, some electrodes may be able to provide an electrical haptic effect when there is liquid to conduct electricity. For such electrodes, providing the electrodes at the outlet 118 may be beneficial in that the user's mouth may provide saliva that may enhance conductance of electricity by the electrodes to provide the electrical haptic effect.

According to an embodiment illustrated in FIG. 3B, the haptic-enabled dispenser 100 for dispensing a consumable substance includes the housing 110 having the passage 310, the temperature sensor 124, the temperature regulator 126, and the control circuit 114. The housing 110 may optionally have the mouthpiece portion 320 and may optionally have the haptic output device 112 thereon. If the haptic output device 112 is implemented, the location of the haptic output device 112 is not limited to the illustrations of FIG. 3B and may be at any portion(s) of the haptic-enabled dispenser 100. The haptic-enabled dispenser 100 may further include a conversion component 120 configured to convert a pre-consumable substance to the consumable substance. As illustrated with the arrows, the housing 110 may be configured to dispense the consumable substance via the passage 310 to an outlet 118 in at least one portion of the passage 310. The temperature sensor 124 may be configured to sense an interior temperature of the haptic-enabled dispenser 100. The control circuit 114 may be configured to generate a temperature control signal based on the interior temperature sensed by the temperature sensor 124 and a target temperature. The temperature regulator 126 may be configured to receive the temperature control signal from the control circuit 114 and to change the interior temperature of the haptic-enabled dispenser 100 to provide a haptic-effect based on the temperature control signal.

In an embodiment, the temperature regulator 126 may include a thermoelectric device to heat or cool an interior of the haptic-enabled dispenser 100 to provide the haptic effect based on the temperature control signal. In an embodiment, the temperature regulator 126 may be a heater included in the conversion component 120 and may be configured to change heat intensity based on the temperature control signal. In an embodiment, the temperature regulator 126 may be a cooler configured to change cooling intensity based on the temperature control signal.

In an embodiment, the control circuit 114 may be configured to determine the target temperature based on at least one of a user input, an exterior temperature, a type of a substance, a cartridge parameter of a cartridge storing the substance, or user interaction data.

According to an embodiment illustrated in FIG. 3C, the haptic-enabled dispenser 100 for dispensing a consumable substance includes the housing 110 having the passage 310, a user input component 132, and the control circuit 114. The housing 110 may optionally have the mouthpiece portion 320. The location of the haptic output device 112 is not limited to the illustrations of FIG. 3C and may be at any portion(s) of the haptic-enabled dispenser 100. The user input component 132 may be configured to receive a user input from a user. The user input component 132 may be any type of device that can be used to receive an input from a user. Therefore, for example, the user input component 132 may include at least one of a mechanical button, a mechanical switch, a touch-sensing button, a touch surface, or a touch screen. In an aspect, the control circuit 114 may be configured to identify a gesture specific to the haptic-enabled dispenser 100 based on the user input (e.g., user touch) received via the user input component 132. The control circuit 114 may be configured to determine a haptic setting based on the user input received via the user input component 132 and to control the haptic output device 112 to generate a haptic effect based on the haptic setting.

According to an embodiment illustrated in FIG. 3D, the haptic-enabled dispenser 100 for dispensing a consumable substance includes the housing 110 having the passage 310, a flow regulator 128, and the control circuit 114. The housing 110 may further include the flow sensor 130. The housing 110 may optionally have the mouthpiece portion 320 and may optionally have the haptic output device 112. The location of the haptic output device 112 is not limited to the illustrations of FIG. 3D and may be at any portion(s) of the haptic-enabled dispenser 100.

The flow regulator 128 may be disposed within the passage 310 and may be configured to regulate a flow of the consumable substance to the outlet 118. The flow regulator 128 may be a device that is capable of changing a flow rate of a substance, such as a valve or a paddlewheel. The control circuit 114 may be configured to control the flow regulator 128 to generate a haptic effect by regulating the flow of the consumable substance to the outlet 118. A change in flow can be perceived in a user mouth or any muscles used to cause the flow of the consumable substance (e.g., via suction by a user mouth). Hence, a user may be able to sense a difference in a flow of the consumable substance, especially when a flow rate is changed, and thus may feel the haptic effect accordingly. For example, when the user consumes the consumable substance, the user may feel a slow pull effect when the flow rate is set to a low setting.

The control circuit 114 may be configured to control the flow regulator 128 to regulate the flow of the consumable substance based on at least one of user interaction data, user input, a cartridge parameter, or a type of the substance. In an embodiment, the control circuit 114 may determine a type of the consumable substance and control the flow regulator to provide different flow rates depending on the type of the consumable substance. In an embodiment, the control circuit 114 may control the flow regulator 128 to provide a first flow rate for the flow of the consumable substance when the type of the consumable substance is a first type and may control the flow regulator to provide a second flow rate for the flow of the consumable substance when the type of the consumable substance is a second type, where the second flow rate is lower than the first flow rate. For example, when the type of the consumable substance is unprocessed tobacco in vapor, then the control circuit 114 may control the flow regulator 128 to provide a slow flow rate to provide a sensation of a slow pull experienced when smoking a cigar. On the other hand, for example, when the type of the consumable substance is a processed tobacco product similar to the cigarette, then the control circuit 114 may control the flow regulator 128 to provide a faster flow rate to provide a sensation of a fast pull experienced when smoking a cigarette.

In an embodiment, the flow regulator 128 may include a valve, and the control circuit 114 may be configured to control opening of the valve to control the flow of the consumable substance to the outlet 118. The flow rate may be increased by opening the valve and may be decreased by closing the valve. Additional details on use of the valve are described infra.

In an embodiment, the flow regulator 128 may include a paddlewheel disposed in the passage 310, and a braking configured to controllably provide resistance against motion of the paddlewheel, where the control circuit 114 is configured to control an amount of the resistance to the motion of the paddlewheel. In some instances, the haptic-enabled dispenser 100 may further include the flow sensor 130 configured to sense a number of rotations of the paddlewheel, where the control circuit 114 may be configured control the flow of the consumable substance based on the number of rotations of the paddlewheel. For example, the number of rotations of the paddlewheel may represent an amount of the consumable substance passing through the paddlewheel. Therefore, the number of rotations of the paddlewheel may be used to determine the amount of the consumable substance dispensed through the outlet 118. In one example, if the number of rotations exceeds a certain threshold (e.g., indicating that a high amount of the consumable substance has been consumed), then the braking component may slow down the rotation of the paddlewheel to reduce the flow rate of the consumable substance. For example, the braking component may be made of piezoelectric material or an electromagnetic material capable of providing the resistance against the rotation of the paddlewheel. The reduction of the flow rate may discourage the user from consuming the consumable substance when the user has already consumed a high amount of the consumable substance. Additional details on use of the paddlewheel are described infra.

In an embodiment, the haptic-enabled dispenser 100 may regulate the flow of the consumable substance based on user interactions with the haptic-enabled dispenser 100. In particular, the haptic-enabled dispenser 100 may further include the user interaction component 142 configured to generate user interaction data indicating user interaction with the haptic-enabled dispenser, where the control circuit 114 may control the flow of the consumable substance based on the user interaction. The user interaction component 142 may be disposed at the outlet 118 of the housing 110, where the user interaction that the user interaction component 142 may detect includes user intake of the consumable substance. The user interaction that the user interaction component 142 may detect may include at least one of an amount of the consumable substance being consumed by a user or a duration of the user consumption of the consumable substance. For example, the user interaction component 142 may be a touch sensor that senses a touch by user (e.g., by user's mouth) at the outlet 118, such that a duration of the user touch at the outlet 118 sensed by the touch sensor may indicate a duration of the user consumption of the consumable substance. For example, the user interaction component 142 may be a pressure sensor or a flow rate sensor that can estimate an amount of the consumable substance exiting the outlet 118 (e.g., into user's mouth).

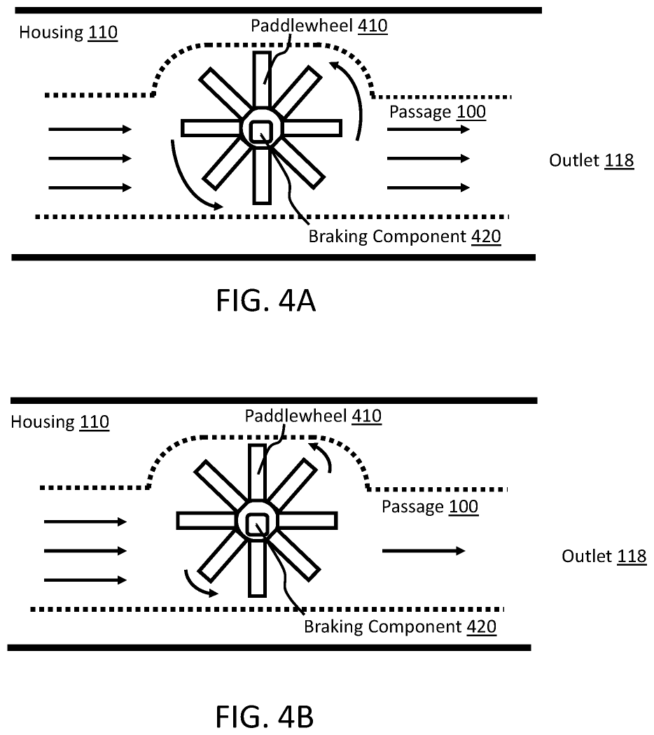

FIGS. 4A and 4B are example diagrams illustrating use of a paddlewheel 410 as the flow regulator 128. FIG. 4A illustrates an instance where the paddlewheel 410 disposed in the passage 100 is allowed to spin without resistance. In the instance of FIG. 4A, when a user attempts to draw the consumable substance into the user mouth at the outlet 118, the paddlewheel 410 may rotate at a speed that corresponds to the flow rate of the consumable substance from the substance storage component 116 to the outlet 118. In an aspect, the flow rate may correspond to the suction pressure that the user applies to draw in the consumable substance into the user mouth. Therefore, with the paddlewheel 410 freely rotating, the flow of the consumable substance through the passage 100 may not be hindered by the paddlewheel 410. On the other hand, in FIG. 4B where a braking component 420 applies resistance against motion of the paddlewheel 410, the paddlewheel 410 may not rotate or may rotate slowly due to the resistance even when there is a flow of the consumable substance through the passage 100. In such an instance, the flow rate of the consumable substance to the outlet 118 may be lower due to the resistance applied to the paddlewheel 410. For example, if the user attempts to draw the consumable substance into the user mouth at the outlet 118, the user may feel the resistance due to the paddlewheel 410 hindering the flow of the consumable substance, thereby feeling the haptic effect.

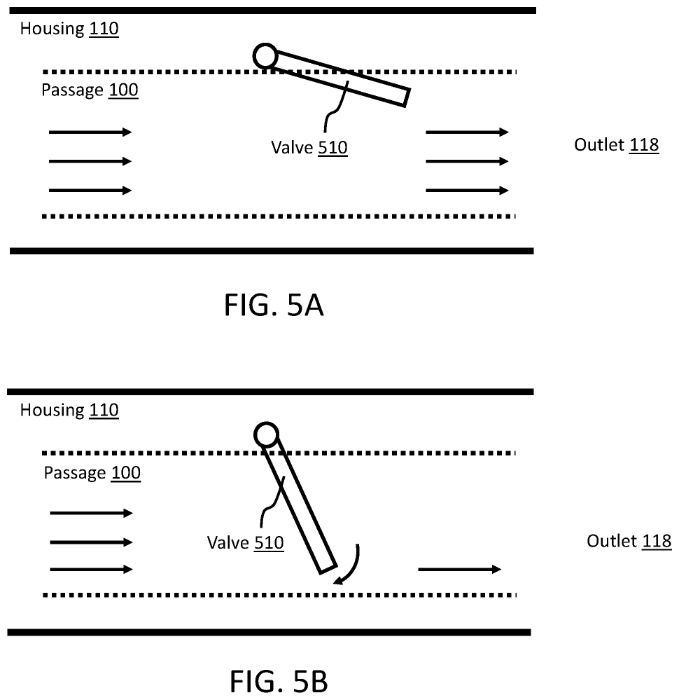

FIGS. 5A and 5B are example diagrams illustrating use of a valve 510 as the flow regulator 128. FIG. 5A illustrates an instance where the valve 510 is open, and thus does not hinder the flow of the consumable substance to the outlet 118. FIG. 5B illustrates an instance where the valve 510 is nearly closed, blocking a large portion of the passage 100. Because the valve 510 in FIG. 5B blocks a large portion of the passage 100 and leaves a small opening, the flow of the consumable substance to the outlet 118 is hindered by the valve 510. The hindrance by the valve 510 in FIG. 5B causes a lower flow rate. Further, if the user attempts to draw the consumable substance into the user mouth at the outlet 118, the user may feel the resistance due to the valve 510 hindering the flow of the consumable substance, thereby feeling the haptic effect.

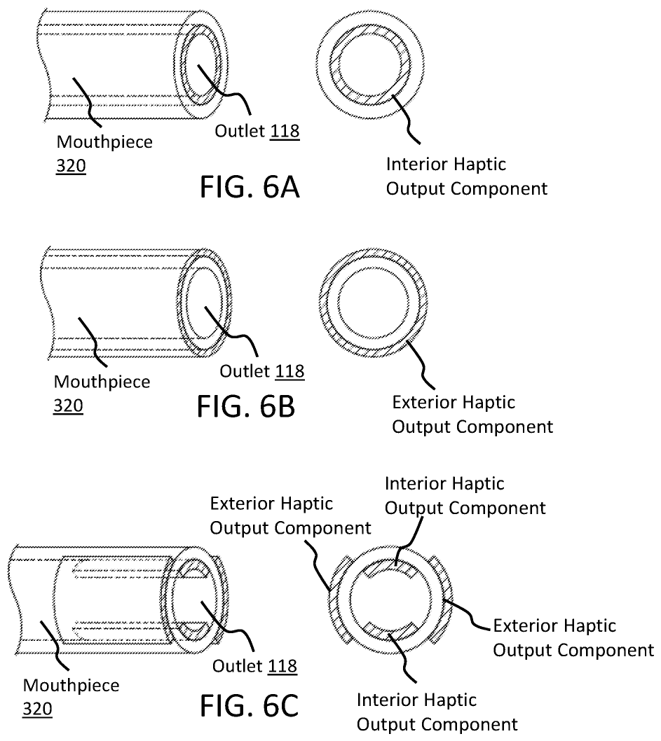

FIGS. 6A-6C are example diagrams illustrating various implementations of the haptic output device 112 near the outlet 118. The left column of FIGS. 6A-6C illustrates a perspective view of the haptic output device 112 near the outlet 118 and the right column of FIGS. 6A-6C illustrates a cross-section view at the outlet 118. The implementation in FIG. 6A is similar to Configuration A of FIG. 3A that implements an interior layer of the interior haptic output component on the interior wall at the mouthpiece portion 320. For example, the interior haptic output component may be a piezoelectric ring capable of vibrating. The implementation in FIG. 6B is similar to Configuration B of FIG. 3A that implements an exterior layer of the exterior haptic output component on the exterior of the mouthpiece portion 320. For example, the exterior haptic output component may be a piezoelectric ring capable of vibrating. The implementation in FIG. 6C is similar to Configuration C of FIG. 3A that implements both the interior layer of the interior haptic output component and the exterior layer of the exterior haptic output component. In FIG. 6C, the interior haptic output component is in two separate parts spaced apart from each other and the exterior haptic output component is also in two separate parts spaced apart from each other. Because the interior haptic output component and the exterior haptic output component are made of parts spaced apart from each other, vibrations by these components may be provided more effectively. In an aspect, the interior haptic output component and the exterior haptic output component may be made of the same type of haptic output device or different types of haptic output devices. For example, the interior haptic output component and/or the exterior haptic output component may be made of a piezoelectric layer.

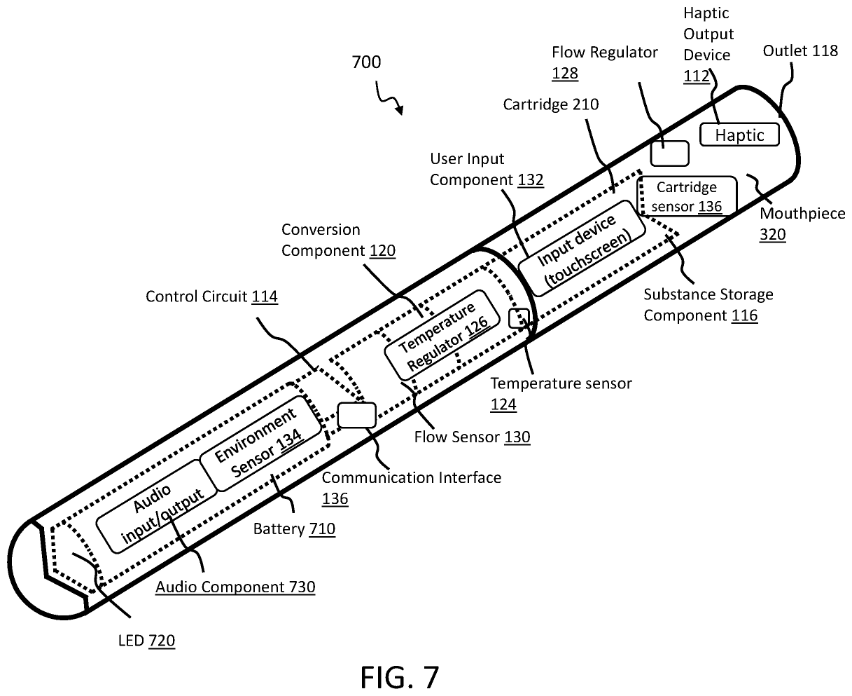

FIG. 7 illustrates an electronic vaping device 700, which is an example of the haptic-enabled dispenser 100. The electronic vaping device 700 may include the haptic output device 112, the control circuit 114, the cartridge 210 coupled to the substance storage component 116, the conversion component 120 connected to the cartridge 210, and a battery 710 to power the control circuit 114 and various components of the electronic vaping device 700. The cartridge 210 may store a substance that is convertible to an inhalable vapor via the conversion component 120 (e.g., an atomizer). The inhalable vapor may travel through a passage within the electronic vaping device 700 and may be dispensed through the outlet 118 at the mouthpiece portion 320.

In an embodiment of the electronic vaping device 700, the control circuit 114 may control the haptic output device 112 to provide a haptic effect based on an inhalation quantity (e.g., a number of inhalation/an amount of inhalation) and further based on a type of the substance stored in the cartridge 210. The type of the substance stored in the cartridge 210 may be determined by reading a cartridge parameter on the cartridge 210 via a cartridge sensor 136. If the substance in the cartridge 210 is a first type that may be harmful to a user, such as a tobacco product, a haptic effect designed to elicit a negative hedonic response in the user may be provided to discourage the user from further inhalation of the inhalable vapor of the first type. In particular, for the substance of the first type, if the inhalation quantity of the inhalable vapor reaches or exceeds an inhalation threshold for the first type, the control circuit 114 may control the haptic output device 112 to provide a first haptic effect that may be unpleasant to a user, so as to discourage the user from further inhalation. In another embodiment, for the substance of the first type, the first haptic effect unpleasant to the user may be present from the beginning, and an intensity of the first haptic effect may increase drastically if the inhalation quantity of the inhalable vapor reaches or exceeds an inhalation threshold. In such an embodiment, the user may always be discouraged from user consumption due to the first haptic effect being always present during user consumption of the substance of the first type, and may be more discouraged from user consumption when the inhalation threshold is reached or exceeded due to the increased intensity of the first haptic effect. The first haptic effect unpleasant to the user may include a vibration in a high frequency (e.g., 170 Hz or above), an intense vibration, an electrical stimulus, etc.

On the other hand, if the substance stored in the cartridge is a second type that provides benefits to a user (e.g., medicinal or therapeutic product providing health benefits), a haptic effect designed to elicit a positive hedonic response in the user may be provided to encourage the user to inhale the inhalable vapor of the second type. In particular, for the substance of the second type, the control circuit 114 may control the haptic output device 112 to provide a second haptic effect that may be pleasant to a user to encourage inhalation by the user until the inhalation quantity of the inhalable vapor reaches an inhalation threshold for the second type. The second haptic effect may one or more of a low frequency vibration, a low intensity vibration, etc. Although the substance of the second type may provide benefits, too much inhalation may still be harmful to the user. Thus, if the inhalation quantity reaches the inhalation threshold, the control circuit 114 may stop the haptic output device 112 from providing the second haptic effect. Further, in an embodiment, when the inhalation quantity exceeds the inhalation threshold, the control circuit 114 may control the haptic output device 112 to provide the first haptic effect unpleasant to the user, to discourage the user from further inhalation. In another embodiment, the control circuit 114 may control the haptic output device 112 to provide the first haptic effect unpleasant to the user when the inhalation quantity reaches or exceeds an excess inhalation threshold that is higher than the inhalation threshold. In an aspect, the first haptic effect and the second haptic effect may be personalized for each user, as different users may prefer different ways to encourage or discourage them.

The inhalation threshold for each type of substance may be set by a manufacturer of the electronic vaping device 700, a user, or authorized personnel. The inhalation threshold may be set to change over time. For example, the inhalation threshold for the first type may be set to decrease over time, such that the user may be able to slowly reduce inhalation quantity over time (e.g., to quit inhaling a tobacco product). Further, the inhalation threshold may be personalized for each user, as different users may have different reactions or difference tolerance levels for each sub stance.

The control circuit 114 may be configured to read a value of a cartridge parameter on the cartridge 210 using the cartridge sensor 136, and control the haptic output device 112 based on the value of the cartridge parameter. The cartridge parameter may indicate one or more of: a type of a substance stored in the cartridge 210, a type of the cartridge 210, a size of the cartridge 210, a manufacturer of the cartridge 210, a manufacturer of the substance stored in the cartridge 210, an amount of the substance stored in the cartridge 210, and a cartridge safety status. For example, as discussed above, the control circuit 114 may control the haptic output device 112 differently based on the type of the substance stored in the cartridge 210. In another example, if the cartridge safety status indicates a cartridge malfunction or an unrecognizable cartridge, a haptic effect may be provided to alert the user. In an aspect, if the control circuit 114 determines any safety issues within the electronic vaping device 700, a haptic effect may be provided to alert the user. The safety issues may be detected using various components in the electronic vaping device, such as the cartridge sensor 136, a temperature sensor 124, the environment sensor 140, etc. For example, if the temperature sensor 124 indicates a high temperature (e.g., higher than a maximum heat threshold), a haptic effect may be provided to alert the user of a possible device malfunction.

The inhalation quantity may be determined by monitoring an airflow through the passage and/or by monitoring a reservoir level of the substance stored in the cartridge 210. The control circuit 114 may monitor the airflow via a flow sensor 130 such as a paddlewheel, where a number of rotations of the paddlewheel may correspond to a flow amount.

In an embodiment, the control circuit 114 may control the haptic output device 112 to simulate various sensations to create illusions. For example, the haptic output device 112 may output vibration and heat to simulate the sensation of crackling of a burning cigarette or bubbling water in a bong, bubbler, or waterpipe. The control circuit 114 may also control to provide a visual feedback via a light source such as the light emitting diode (LED) 720 and/or an audio feedback via an audio input/output device 730 (e.g., speaker), to further simulate the burning cigarette or the bubbling water. In an aspect, the control circuit 114 may determine a type of sensations based on a type of the substance stored in the cartridge 210 and/or other information provided in the cartridge 210. For example, if the cartridge parameter indicates that the substance is a cigarette-like tobacco product, user setting for the tobacco product may be to provide the sensation of the burning cigarette. In another example, if the cartridge parameter indicates that the substance is an unprocessed tobacco product, the user setting for such a product may be to provide the sensation of the bubbling water of a bong, bubbler, or waterpipe. The haptic effect may be synchronized to user breath, such that the control circuit 114 triggers the haptic effect when user inhalation is detected (e.g., via the flow sensor 130). In an embodiment, the electronic vaping device 700 may also be capable of providing taste feedback and/or aroma feedback, etc.

In an aspect, the haptic effect may be provided based on an airflow, e.g., airflow rate and/or a direction of the airflow. In the above example, if the flow sensor 130 detects a higher airflow rate due to a fast pull inhalation by the user, the control circuit 114 may control the haptic output device 112 to provide a more intense haptic effect (e.g., to simulate more crackling in a burning cigarette or more bubbling in a bong, bubbler, or waterpipe). On the other hand, if the flow sensor 130 detects a lower airflow rate due to a slow pull inhalation by the user, the control circuit 114 may control the haptic output device 112 to provide a less intense haptic effect (e.g., to simulate less crackling in a burning cigarette or less bubbling in a bong, bubbler, or waterpipe.). In addition, the sensation may be simulated to indicate a reservoir level of the substance stored in the cartridge. For example, more heat may be provided to indicate a low reservoir level, by simulating a cigarette burning close to user fingers on a cigarette filter.

In an embodiment, the haptic effect may be associated with a model/brand of the electronic vaping device 700 and/or a model/brand of the cartridge 210. Because different models/brands of the electronic vaping device 700 may have different structures and/or different parts, the haptic effect may be adjusted depending on the models/brands, e.g., for consistency in the haptic effect throughout different models/brands.

The electronic vaping device 700 may include the communication interface 136 to communicate with another device such as a mobile device or a cloud storage device. For example, a user may create a haptic track using the user input component 132 and share the haptic track with a user community by uploading the haptic track to a cloud storage device. The communication interface 136 may also be used to download a haptic track from another device. As such, the haptic tracks for various haptic effects may be stored in another device and may be downloaded when a particular haptic track is needed. In an embodiment, another device may provide a notification (e.g., push notification) to the electronic vaping device 700 via the communication interface 136, such that the haptic output device 112 may provide a haptic feedback corresponding to the notification. For example, the haptic output device 112 may vibrate when a push notification indicating an upcoming appointment is received from a cloud storage device that has user calendar information.

In an embodiment, a haptic effect may be provided using a flow regulator 128, by providing different types of airflow. Because a user generally inhales the inhalable vapor through the outlet 118, a change in the airflow within a passage to the outlet 118 can be perceived by the user, thus creating a haptic effect. For example, the paddlewheel or the valve shown in FIGS. 4 and 5 and discussed above may be used as the flow regulator 128. As discussed above, for example, the flow regulator 128 may be used to provide a slow pull effect to simulate smoking a cigar may be provided by reducing the flow rate of the inhalable vapor. In another example, the flow regulator 128 may be used to provide a faster pull effect experienced when smoking a cigarette may be provided by increasing the flow rate of the inhalable vapor. Further, for example, the flow regulator 128 may be used to provide a very fast pull effect by increasing the flow rate of the inhalable vapor to maximum.

In an embodiment, the environment sensor 140 may sense environment information on a surrounding environment such that the control circuit 114 may control the haptic output device 112 to provide a haptic effect based on the environment information. The environment information may include at least one of sound information, brightness information, temperature information, weather information, location information, or speed information. For example, in a case where the environment sensor 140 senses music, the haptic output device 112 may be controlled to vibrate according to a certain pattern in the music sensed by the environment sensor 140, which may enhance music listening experience along with inhalation experience. The haptic pattern for a certain environment (e.g., a particular song) may be pre-defined or may be automatically generated based on the sensed environment information (e.g., audio signal from a song).

In an embodiment, the control circuit 114 may control the temperature regulator 126 to provide heating or cooling at the electronic vaping device 700. In an aspect, the control circuit 114 may sense the temperature at the electronic vaping device 700 via the temperature sensor 124 and then control the temperature regulator 126 to provide a heating effect or a cooling effect to maintain a temperature comfortable to a user. In one example, the temperature regulator 126 may be used to regulate the temperature of the vapor to be inhaled by the user. In an aspect, the temperature regulator 126 may be a thermoelectric device (e.g., Peltier device) capable of providing heating and/or cooling effects. In another aspect, the control circuit 114 may control the temperature regulator 126 to provide a heating effect or a cooling effect as a feedback (e.g., device status, notification, haptic feedback to simulate a sensation and/or property, etc.). For example, the temperature regulator 126 may be controlled to provide a cooling effect as an indication that a reservoir level in the cartridge 210 is low. In an aspect, the temperature regulator 126 may be a part of the heater (e.g., atomizer) in the conversion component 120.

The user input component 132 in the electronic vaping device 700 may be used to sense various user gestures that are specific to the electronic vaping device 700. For example, the user input component 132 may include a touch sensing device, and the control circuit 114 may be configured to identify user gestures via the touch sensing device. The control circuit 114 may control the haptic effect by the haptic output device 112 based on the identified gesture. The user gestures specific to the electronic vaping device 700 may include lips surrounding the mouthpiece portion 320, turning the electronic vaping device 700 with fingertips, sliding fingers along the electronic vaping device 700, wrapping around the electronic vaping device 700 with a hand, holding the electronic vaping device 700 between fingers, etc. For example, the gesture of lips surrounding the mouthpiece portion 320 may activate the haptic effect. In another example, sliding fingers along the electronic vaping device 700 may increase or decrease an intensity of the haptic effect.

In an embodiment, the control circuit 114 may consider a battery level of the battery 710 to control the haptic output device 112. For example, when a battery level falls below a low battery threshold, the control circuit 114 may determine to provide a less intense haptic effect or selectively deactivate certain haptic effects or deactivate all haptic effects, in order to conserve battery power.

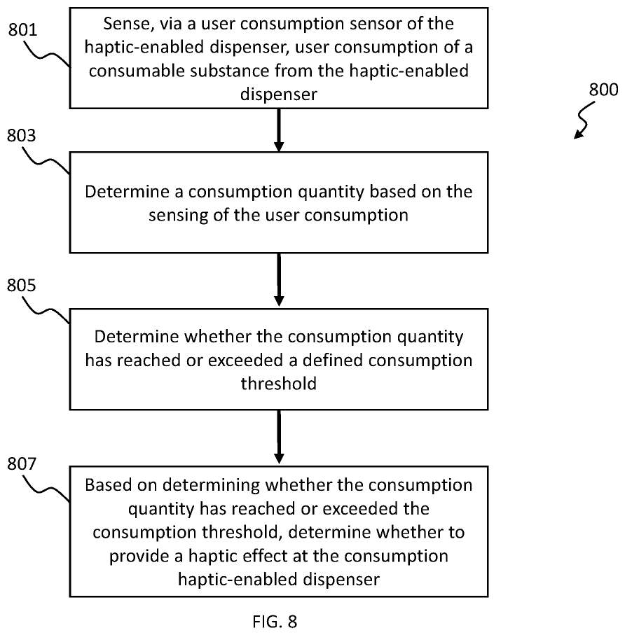

FIG. 8 depicts a flow diagram for a method 800 for generating haptic effects on the haptic-enabled dispenser 100 for dispensing consumable substance, according to embodiments herein. In an embodiment, the method 800 starts at step 801, in which the control circuit 114 senses, via a user consumption sensor 134 of the haptic-enabled dispenser 100, user consumption of a consumable substance from the haptic-enabled dispenser 100.

In step 803, the control circuit 114 determines a consumption quantity based on the sensing of the user consumption. In an aspect, the consumption quantity may include at least one of a number of consumption events, a consumption duration, or an amount of consumption of the consumable substance.

In step 805, the control circuit 114 determines whether the consumption quantity has reached or exceeded a defined consumption threshold.

In step 807, based on determining whether the consumption quantity has reached or exceeded the consumption threshold, the control circuit 114 determines whether to provide a haptic effect at the consumption haptic-enabled dispenser 100.

In an embodiment, the control circuit 114 determines a type of the consumable substance, where the control circuit 114 determines whether to provide the haptic effect based on the type of the consumable substance.

In an embodiment, when the type of the consumable substance is a first type, in response to determining that the consumption quantity has reached or exceeded the consumption threshold, the control circuit 114 generates a first control signal to provide a first haptic effect at the haptic-enabled dispenser 100. Further, in such an embodiment, in response to determining that the consumption quantity has exceeded the consumption threshold, the control circuit 114 may determine an excess consumption quantity indicating how much the consumption quantity has exceeded the consumption threshold, and the first haptic effect based on the excess consumption quantity. In an embodiment, the control circuit 114 may adjust the first haptic effect by increasing at least one of intensity of the first haptic effect or a duration of the first haptic effect as the excess consumption quantity increases.

In an embodiment, when the type of the consumable substance is a second type, in response to determining that the consumption quantity has neither reached nor exceeded the consumption threshold, the control circuit 114 generates a second control signal to provide a second haptic effect at the haptic-enabled dispenser 100. In such an embodiment, in response to determining that the consumption quantity has reached or exceeded the consumption threshold, the control circuit 114 may refrain from generating the second control signal for providing the second haptic effect at the haptic-enabled dispenser 100. In an embodiment, in response to determining that the consumption quantity has exceeded the consumption threshold, the control circuit 114 may generate a first control signal to provide a first haptic effect at the haptic-enabled dispenser 100. In another embodiment, in response to determining that the consumption quantity has reached or exceeded a second consumption threshold that is greater than the consumption threshold, the control circuit 114 may generate a first control signal to provide a first haptic effect at the haptic-enabled dispenser 100.

In an embodiment, the control circuit 114 may sense the user consumption by sensing a flow of the consumable substance through the haptic-enabled dispenser 100 and/or by sensing a reservoir level of the consumable substance held by the haptic-enabled dispenser 100. In such an embodiment, the flow may be sensed via a paddlewheel disposed in a passage of the flow within the haptic-enabled dispenser 100, the flow being sensed based on a number of rotations of the paddlewheel.

In an embodiment, the consumption threshold is set by at least one of a user input to the haptic-enabled dispenser 100, a manufacturer setting of the haptic-enabled dispenser 100, or communication with an external device.

In an embodiment, the consumption threshold is set to change over time.

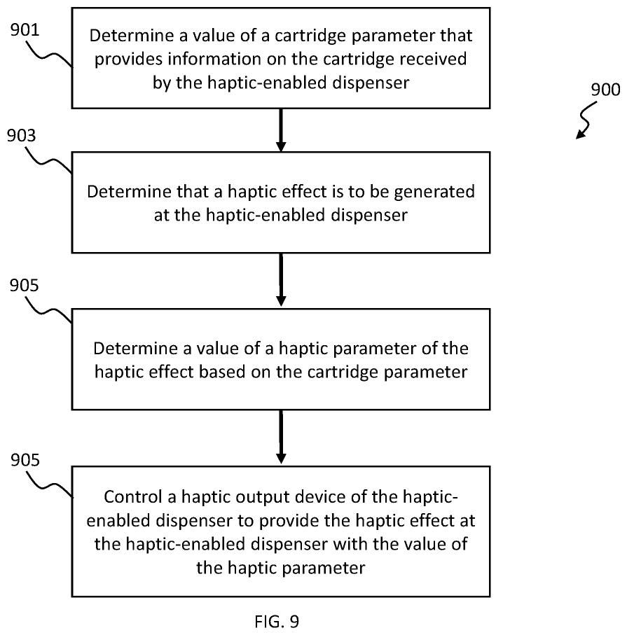

FIG. 9 depicts a flow diagram for a method 900 for generating haptic effects on the haptic-enabled dispenser 100 for dispensing consumable substance, according to embodiments herein. The haptic-enabled dispenser 100 may be configured to receive a cartridge 210 storing the consumable substance. In an embodiment, the method 900 starts at step 901, in which the control circuit 114 determines a value of a cartridge parameter that provides information on the cartridge received by the haptic-enabled dispenser 100. In an aspect, the control circuit 114 may determine the value of the cartridge parameter by reading cartridge information on the cartridge. In an aspect, the cartridge parameter may indicate at least one of a type of a substance stored in the cartridge, a type of the cartridge, a size of the cartridge, a manufacturer of the cartridge, a reservoir level of the cartridge, or a cartridge safety status.

In an aspect where the cartridge parameter includes the cartridge safety status, the control circuit 114 may determine the value of the cartridge parameter by performing at least one of: determining whether the cartridge is recognized by the haptic-enabled dispenser 100, or determining whether the cartridge is malfunctioning.

In step 903, the control circuit 114 determines that a haptic effect is to be generated at the haptic-enabled dispenser 100.

In step 905, the control circuit 114 determines a value of a haptic parameter of the haptic effect based on the cartridge parameter.

In step 907, the control circuit 114 controls a haptic output device of the haptic-enabled dispenser 100 to provide the haptic effect at the haptic-enabled dispenser 100 with the value of the haptic parameter. In an aspect where the type of the substance indicated in the cartridge parameter is a tobacco product, the haptic effect may include at least one of heat or vibration. In such an aspect, the haptic effect may be provided with a light and a sound during each consumption.

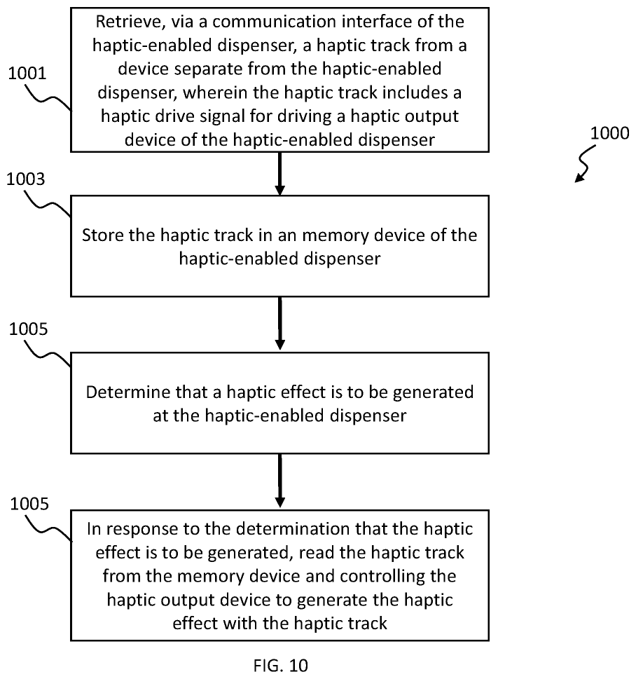

FIG. 10 depicts a flow diagram for a method 1000 for generating haptic effects on the haptic-enabled dispenser 100 for dispensing consumable substance, according to embodiments herein. In an embodiment, the method 1000 starts at step 1001, in which the control circuit 114 retrieves, via the communication interface 136, a haptic track from a device separate from the haptic-enabled dispenser 100, where the haptic track includes a haptic drive signal for driving the haptic output device 112.

At step 1003, the control circuit 114 stores the haptic track in the memory device 122 of the haptic-enabled dispenser 100.

At step 1005, the control circuit 114 determines that a haptic effect is to be generated at the haptic-enabled dispenser 100.

At step 1007, in response to the determination that the haptic effect is to be generated, the control circuit 114 reads the haptic track from the memory device and controlling the haptic output device to generate the haptic effect with the haptic track.

In an embodiment, the control circuit 114 may receive, via an input device of the haptic-enabled dispenser 100, an input, and perform at least one of modifying the haptic track based on the input or generating a new haptic track based on the input. In such an embodiment, the control circuit 114 may transmit, via the communication interface, at least one of the modified haptic track or the new haptic track.

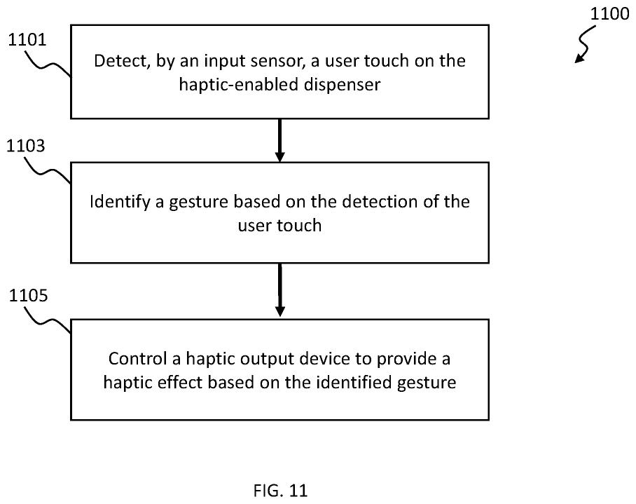

FIG. 11 depicts a flow diagram for a method 1100 for generating haptic effects on the haptic-enabled dispenser 100 for dispensing consumable substance, according to embodiments herein. In an embodiment, the method 1100 starts at step 1101, in which the control circuit 114 detects, by an input sensor, a user touch on the haptic-enabled dispenser 100.

In step 1103, the control circuit 114 identifies a gesture based on the detection of the user touch. In an aspect, the identified gesture may include at least one of: turning the haptic-enabled dispenser 100 with fingertips, sliding along the haptic-enabled dispenser 100 with fingers, wrapping around the haptic-enabled dispenser 100 with a hand, or holding the haptic-enabled dispenser 100 between fingers.

In step 1105, the control circuit 114 controls a haptic output device to provide a haptic effect based on the identified gesture.

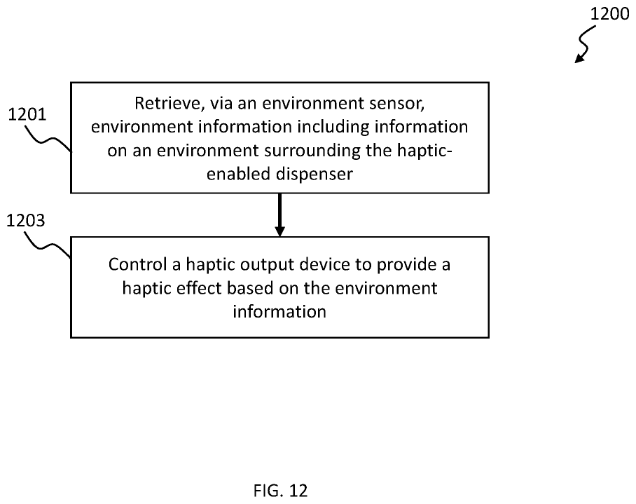

FIG. 12 depicts a flow diagram for a method 1200 for generating haptic effects on the haptic-enabled dispenser 100 for dispensing consumable substance, according to embodiments herein. In an embodiment, the method 1200 starts at step 1201, in which the control circuit 114 retrieves, via an environment sensor, environment information including information on an environment surrounding the haptic-enabled dispenser 100. In an aspect, the environment information may include at least one of sound information, brightness information, temperature information, weather information, location information, or speed information.

In step 1203, the control circuit 114 controls a haptic output device to provide a haptic effect based on the environment information.

In an aspect where the environment information is sound information including music, the control circuit 114 may retrieve the environment information by sensing at least one of an audio signal of the music or haptic information associated with the music, and generating a control signal for the haptic output device to provide the haptic effect based on at least one of the audio signal or the haptic information.

While various embodiments have been described above, it should be understood that they have been presented only as illustrations and examples of the present invention, and not by way of limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

What is claimed is:

1. A haptic-enabled dispenser for dispensing a consumable substance, comprising:
a housing having a passage and a haptic portion, the housing configured to dispense the consumable substance via the passage to an outlet of the housing;
a haptic output device disposed at a haptic portion of the housing; and
a control circuit configured to control the haptic output device to generate a haptic effect at the haptic portion of the housing of the haptic-enabled dispenser.

2. The haptic-enabled dispenser of claim 1, wherein the consumable substance includes at least one of an inhalable vapor, an inhalable aerosol, an ingestible liquid, or an ingestible solid.

3. The haptic-enabled dispenser of claim 1, further comprising a user interaction component configured to collect user interaction data including information on user interaction with the haptic-enabled dispenser, wherein the control circuit is configured to control the haptic output device to generate the haptic effect based on the user interaction data.

4. The haptic-enabled dispenser of claim 3, wherein the interaction data includes at least one of a dispensed amount of the consumable substance, user touch data, or a position data with respect to a user position and a position of the haptic-enabled dispenser.

5. The haptic-enabled dispenser of claim 1, further comprising a memory device configured to store data and a communication interface configured to perform data communication, wherein the control circuit is configured to receive a haptic track via the communication interface, and to store the haptic track on the memory device, wherein the haptic effect is generated based on the haptic track.

6. The haptic-enabled dispenser of claim 1, wherein the haptic output device comprises an actuator configured to vibrate to provide the haptic effect, at least one electrode disposed on a surface of the housing to provide the haptic effect, a temperature regulator configured to change a temperature within the housing to generate the haptic effect, a flow regulator configured to regulate a flow of the substance through the passage to generate the haptic effect, or a combination thereof.

7. The haptic-enabled dispenser of claim 6, wherein the haptic output device is configured to generate at least one of a vibrotactile effect, electrical stimulus effect, a thermal effect, a friction effect, a force effect, or an ultrasonic effect.

8. The haptic-enabled dispenser of claim 1, wherein the housing has an interior wall that forms the passage, and
wherein the haptic output device comprises at least one of an interior layer of an interior haptic output component directly disposed on the interior wall at the haptic portion or an exterior layer of an exterior haptic output component disposed on an exterior of the haptic portion.

9. The haptic-enabled dispenser of claim 8, wherein the interior haptic output component comprises a plurality of interior haptic output components spaced apart from one another, and the exterior haptic output component comprises a plurality of exterior haptic output components spaced apart from one another.

10. The haptic-enabled dispenser of claim 8, wherein the interior haptic output component is configured to generate a first haptic effect and the exterior haptic output component is configured to generate a second haptic effect different from the first haptic effect.

11. The haptic-enabled dispenser of claim 1, further comprising:
a flow sensor to sense a flow rate of the consumable substance through the passage,
wherein the control circuit is further configured to control the haptic output device to adjust an intensity of the haptic effect based on the flow rate of the consumable substance.

12. The haptic-enabled dispenser of claim 1, wherein the housing further comprises at least one of a mouthpiece portion or a handle portion, the at least one of the mouthpiece portion or the handle portion having the haptic portion.

13. A haptic-enabled dispenser for dispensing a consumable substance, comprising:
a housing having a passage and configured to dispense the consumable substance via the passage to an outlet in at least one portion of the passage;
a temperature sensor configured to sense an interior temperature of the haptic-enabled dispenser;
a control circuit configured to generate a temperature control signal based on the interior temperature sensed and a target temperature; and
a temperature regulator configured to receive the temperature control signal and to change the interior temperature of the haptic-enabled dispenser to provide a haptic-effect based on the temperature control signal.

14. The haptic-enabled dispenser of claim 13, wherein the temperature regulator comprises a thermoelectric device to heat or cool an interior of the haptic-enabled dispenser to provide the haptic effect based on the temperature control signal.

15. The haptic-enabled dispenser of claim 13, further comprising a conversion component configured to convert a pre-consumable substance to the consumable substance, wherein the temperature regulator includes at least one of a heater included in the conversion component and configured to change heat intensity based on the temperature control signal or a cooler configured to change cooling intensity based on the temperature control signal.

16. The haptic-enabled dispenser of claim 13, wherein the control circuit is configured to determine the target temperature based on at least one of a user input, an exterior temperature, a type of a substance, a cartridge parameter of a cartridge storing the substance, or user interaction data.

17. A haptic-enabled dispenser for dispensing a consumable substance, comprising:
a housing having a passage and configured to dispense the consumable substance via the passage to an outlet in at least one portion of the passage;
a flow regulator disposed within the passage and configured to regulate a flow of the consumable substance to the outlet;
a control circuit configured to control the flow regulator to generate a haptic effect by regulating the flow of the consumable substance to the outlet.

18. The haptic-enabled dispenser of claim 17, wherein the control circuit is configured to
determine a type of the consumable substance,
control the flow regulator to provide a first flow rate for the flow of the consumable substance when the type of the consumable substance is a first type, and
control the flow regulator to provide a second flow rate for the flow of the consumable substance when the type of the consumable substance is a second type, the second flow rate being lower than the first flow rate.

19. The haptic-enabled dispenser of claim 17, wherein the flow regulator comprises a valve, and the control circuit is configured to control opening of the valve to control the flow of the consumable substance to the outlet.

20. The haptic-enabled dispenser of claim 17, wherein the flow regulator comprises:
a paddlewheel disposed in the passage, and
a braking component configured to controllably provide resistance against motion of the paddlewheel, wherein the control circuit is configured to control an amount of the resistance to the motion of the paddlewheel.
